(19) United States
(12) Patent Application Publication
(10) Pub. No.: US 2019/0199833 A1
(43) Pub. Date: Jun. 27, 2019

(54) TRANSMISSION DEVICE, METHOD, PROGRAM, AND RECORDING MEDIUM

(71) Applicant: NEC CORPORATION, Tokyo (JP)

(72) Inventor: Yohei HASEGAWA, Tokyo (JP)

(73) Assignee: NEC CORPORATION, Tokyo (JP)

(21) Appl. No.: 16/302,229

(22) PCT Filed: May 15, 2017
(86) PCT No.: PCT/JP2017/018208

§ 371 Date: Nov. 16, 2018

(30) Foreign Application Priority Data
May 18, 2016 (JP) 2016-099698

(51) Int. Cl. H04L 29/06; H04L 1/18; H04L 5/00; H04L 29/08

(52) U.S. Cl. CPC H04L 69/04; H04L 1/18; H04L 69/163; H04L 5/0055; H04L 69/324; H04L 5/0044

(57) ABSTRACT

In order to enable a delay until the output of retransmission data to be reduced, performing transfer of a data piece that is input from a data input unit to a first transfer unit, performing determination of necessity of retransmission of the data piece, when the retransmission is determined to be necessary, performing transfer of a retransmission data piece that is necessary to be retransmitted to a second transfer unit, and in advance of at least any of the data piece remaining in the first transfer unit at a point of time of the transfer of the retransmission data piece to the second transfer unit, performing output of the retransmission data piece in the second transfer unit to a same destination as that of the data piece in the first transfer unit.

### TECHNICAL FIELD

The present invention relates to a transmission device, a transmission method, a transmission program, and a recording medium that detect loss of data transmitted to a reception device and perform retransmission of the lost data.

### BACKGROUND ART

The transmission control protocol/internet protocol (TCP/IP), which is a representative communication protocol used on the Internet, assures an application using the TCP/IP of integrity in data transfer. That is, when data transmitted by a transmission device are lost in the transmission device, a network, or a reception device, the transmission device retransmits the lost data. The reception device sorts and restores received data into original data and transfers the restored data to an application on the reception side.

Recent years, cloud-type services in each of which a data center holds user data and the like and a service provider provides a service adapted to each user have been expanding. In such cloud-type services, distance between a data center and a user terminal sometimes becomes substantially long. For this reason, a communication method that is capable of providing sufficient communication speed regardless of communication distance between a data center and a user terminal is desired to be developed.

In order to achieve such a high-speed, long-distance communication, each of a transmission device, a network, and a reception device requires a buffer for storing more data or packets temporarily. In particular, a transmission device that determines a communication speed first requires a large buffer. In recent years, in order to utilize a long-distance line having a communication speed of 10 Gbps, transmission devices often include buffers with capacities of 300 MB, 300 MB, and 100 MB in the TCP layer, the IP layer, and the data link layer, respectively.

Basically, when a large buffer is set up to achieve high-speed communication, a possibility that a large transfer delay occurs increases when data are retransmitted. In general TCP/IP communication, one communication path is used in data transfer between a pair of a transmission device and a reception device. A data link layer, which is represented by Ethernet (registered trademark), also uses one communication path in principle, and data transfer order does not change in the data link layer. For this reason, retransmission data are caused to be transferred at the end of all data in transmission, which causes transmission waiting time to increase.

In FIG. 19, an example of general data transfer using TCP/IP is illustrated. A transmission device transmits a data piece to a reception device, and the reception device replies an acknowledgment (ACK) for the data piece to the transmission device. While the transmission device performs communication through respective processing layers including an application layer, a TCP layer, an IP layer, and an Ethernet layer, the TCP and lower layers are illustrated in FIG. 19.

Sequence numbers are respectively provided to data pieces and ACKs. Hereinafter, sequence numbers provided to data pieces and sequence numbers provided to ACKs are referred to as data numbers and ACK numbers, respectively. In FIG. 19, transmission of data pieces with data number 11 and later that are output from the TCP layer is illustrated. For the sake of simplicity, it is assumed that the TCP layer of the transmission device is capable of transmitting data pieces up to a data piece with a data number calculated by adding 6 to the ACK number of an ACK that has been received.

Data pieces that the TCP layer output are buffered in each of the IP layer and the Ethernet layer and are successively output from the Ethernet layer. In FIG. 19, a data piece is transmitted with respect to each row. It is assumed that a data piece and six data pieces can be buffered in the Ethernet layer and the IP layer, respectively. The reception device sets a number succeeding a data number of a data piece that the reception device has just received (in other words, a data number of a data piece that the reception device expects to receive next) to an ACK number.

In the example in FIG. 19, it is assumed that a data piece 12 is lost in the network. When the reception device receives a data piece 13, the reception device replies an ACK 12 because a data piece which the reception device has expected to arrive is the data piece 12. Until the data piece 12 arrives, the reception device replies the ACK 12 when receiving a data piece other than the data piece 12.

The TCP layer of the transmission device determines that the data piece 12 was lost based on the fact that three identical ACKs (ACK 12) have arrived and retransmits the data piece 12 (underlined). At this time, data pieces 17 and 18 are contained in the buffers in the Ethernet layer and the IP layer in the transmission device. For this reason, the data piece 12 is to be transmitted after the data pieces 17 and 18. In addition, during a period from a point of time when the data piece 12 arrived at the reception device to a point of time when an ACK (ACK 19) arrives at the transmission device, data pieces that the transmission device can transmit are data pieces up to the data piece 18 (calculated by adding 6 to the ACK number (12)). For this reason, the transmission device cannot transmit a data piece 19 and succeeding data pieces, and the transmission is thus caused to stop temporarily.

Meanwhile, methods for transferring retransmission data preferentially over other data are described in PTLs 1 and 2.

PTL 1 proposes a method of detecting a retransmission packet, based on header information and rewriting a value in the type of service (ToS) field in the IP header of the retransmission packet to a value indicating a degree of priority higher than that for normal transmission. This method enables a device at a succeeding stage to preferentially transfer retransmission data according to a value in the ToS field.

PTL 2 proposes a method of encapsulating a retransmission packet by use of the user datagram protocol (UDP) and preferentially transferring the retransmission packet at a device at a succeeding stage.

### CITATION LIST

### Patent Literature

[PTL 1] WO 2002/051101 A

[PTL 2] JP 2014-049905 A

### SUMMARY OF INVENTION

### Technical Problem

However, both methods described in PTLs 1 and 2 are methods that enable preferential processing by a device at a succeeding stage and do not allow retransmission data to be preferentially processed in the transmission device.

Even when, as in the method described in PTL 1, the ToS field of a retransmission packet is rewritten in the IP layer, the retransmission packet cannot, in the data link and lower layers, be preferentially processed because the ToS field is not referred to in the layers. Even when, as in the method described in PTL 2, a retransmission packet is encapsulated by use of UDP, processing in the IP and lower layers is not affected.

For this reason, both methods described in PTLs 1 and 2 cannot solve a problem in that a delay until the output of retransmission data from a transmission device increases.

An object of the present invention is to provide a transmission device, a transmission method, a transmission program, and a recording medium that enable a delay until the output of retransmission data to be reduced.

### Solution to Problem

For settling the above-mentioned problem, a transmission device according to an exemplary aspect of the invention comprises: a data input means for inputting a data piece, a first transfer means, a second transfer means, a data transmission means for performing transfer of the data piece to the first transfer means, a retransmission control means for performing determination of necessity of retransmission of the data piece, a retransmission data transmission means for, when the retransmission is determined to be necessary, performing transfer of a retransmission data piece that is necessary to be retransmitted to the second transfer means, and an input/output processing means for, in advance of at least any of the data piece remaining in the first transfer means at a point of time of the transfer of the retransmission data piece to the second transfer means, performing output of the retransmission data piece in the second transfer means to a same destination as that of the data piece in the first transfer means.

And, a transmission method according to an exemplary aspect of the invention comprises: performing transfer of a data piece that is input from a data input unit to a first transfer unit, performing determination of necessity of retransmission of the data piece, when the retransmission is determined to be necessary, performing transfer of a retransmission data piece that is necessary to be retransmitted to a second transfer unit, and in advance of at least any of the data piece remaining in the first transfer unit at a point of time of the transfer of the retransmission data piece to the second transfer unit, performing output of the retransmission data piece in the second transfer unit to a same destination as that of the data piece in the first transfer unit.

And, a computer readable recording medium according to an exemplary aspect of the invention is recorded with a transmission program causing a computer to execute: a data transmission function of performing transfer of a data piece that is input from a data input unit to a first transfer unit, a retransmission control function of performing determination of necessity of retransmission of the data piece, a retransmission data transmission function of, when the retransmission is determined to be necessary, performing transfer of a retransmission data piece that is necessary to be retransmitted to a second transfer unit, and an input/output processing function of, in advance of at least any of the data piece remaining in the first transfer unit at a point of time of the transfer of the retransmission data piece to the second transfer unit, performing output of the retransmission data piece in the second transfer unit to a same destination as that of the data piece in the first transfer unit.

### Advantageous Effects of Invention

A transmission device, a transmission method, a transmission program, and a recording medium of the present invention enable a delay until the output of retransmission data to be reduced.

### BRIEF DESCRIPTION OF DRAWINGS

FIG. 1 shows a diagram illustrating a configuration example of a transmission device of a first example embodiment of the present invention.

FIG. 2 shows a diagram illustrating an operation example of the transmission device of the first example embodiment of the present invention.

FIG. 3 shows a diagram illustrating a configuration example of a transmission system of a second example embodiment of the present invention.

FIG. 4 shows a diagram illustrating a configuration example of a transmission device of the second example embodiment of the present invention.

FIG. 5 shows a diagram illustrating a configuration example of a reception device of the second example embodiment of the present invention.

FIG. 6 shows a diagram illustrating an example of a correspondence relationship between processing layers and logical and physical processing units of the transmission device of the second example embodiment of the present invention.

FIG. 7 shows a diagram illustrating an example of data transfer by the transmission device of the second example embodiment of the present invention.

FIG. 8 shows a diagram illustrating an operation example of the transmission device of the second example embodiment of the present invention.

FIG. 9 shows a diagram illustrating an operation example of the transmission device of the second example embodiment of the present invention.

FIG. 10 shows a diagram illustrating still an operation example of the transmission device of the second example embodiment of the present invention.

FIG. 11 shows a diagram illustrating a configuration example of a transmission device of a third example embodiment of the present invention.

FIG. 12 shows a diagram illustrating an operation example of the transmission device of the third example embodiment of the present invention.

FIG. 13 shows a diagram illustrating a configuration example of a transmission device of a fourth example embodiment of the present invention.

FIG. 14 shows a diagram illustrating a configuration example of transmission devices of fifth and sixth example embodiments of the present invention.

FIG. 15 shows a diagram illustrating another configuration example of the transmission device of the sixth example embodiment of the present invention.

FIG. 16 shows a diagram illustrating an operation example of the transmission device of the sixth example embodiment of the present invention.

FIG. 17 shows a diagram illustrating an operation example of a transmission device of a seventh example embodiment of the present invention.

FIG. 18 shows a diagram illustrating a hardware configuration example of the respective example embodiments of the present invention.

FIG. 19 shows a diagram illustrating an example of data transfer by a general transmission device.

FIG. 20 shows a diagram illustrating an example of a correspondence relationship between processing layers and logical and physical processing units of the general transmission device.

### EXAMPLE EMBODIMENT

### First Example Embodiment

A first example embodiment of the present invention will be described.

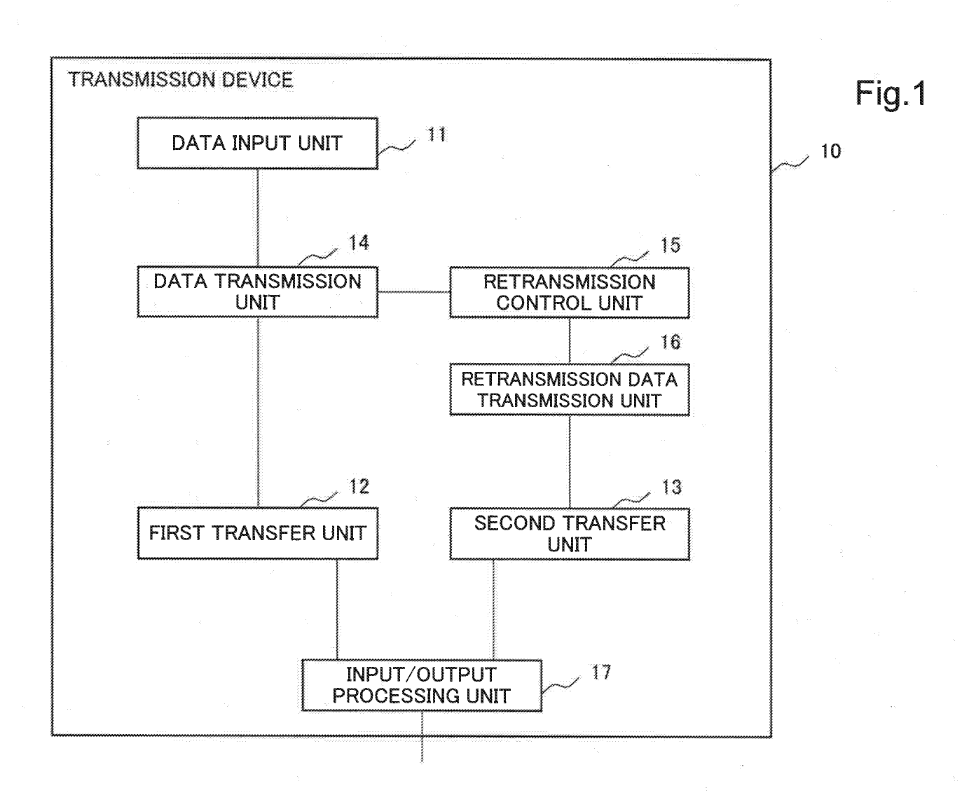

In FIG. 1, a configuration example of a transmission device 10 of the present example embodiment is illustrated. The transmission device 10 of the present example embodiment is configured including a data input unit 11, a first transfer unit 12, a second transfer unit 13, a data transmission unit 14, a retransmission control unit 15, a retransmission data transmission unit 16, and an input/output processing unit 17.

The data input unit 11 is a component that inputs data. The data transmission unit 14 is a component that transfers a data piece to the first transfer unit 12. The retransmission control unit 15 is a component that determines necessity of retransmission of a data piece. The retransmission data transmission unit 16 is a component that, when retransmission is determined to be necessary, transfers a retransmission data piece necessary to be retransmitted to the second transfer unit 13. The input/output processing unit 17 is a component that, in advance of at least any of a data piece(s) remaining in the first transfer unit 12 at a point of time of transfer of a retransmission data piece to the second transfer unit 13, outputs the retransmission data piece in the second transfer unit 13 to the same destination as that of the data piece(s) in the first transfer unit 12.

Configuring the transmission device 10 in this way causes the transmission device 10 to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in a buffer in the first transfer unit 12. As a result, a delay until the output of a retransmission data piece can be reduced.

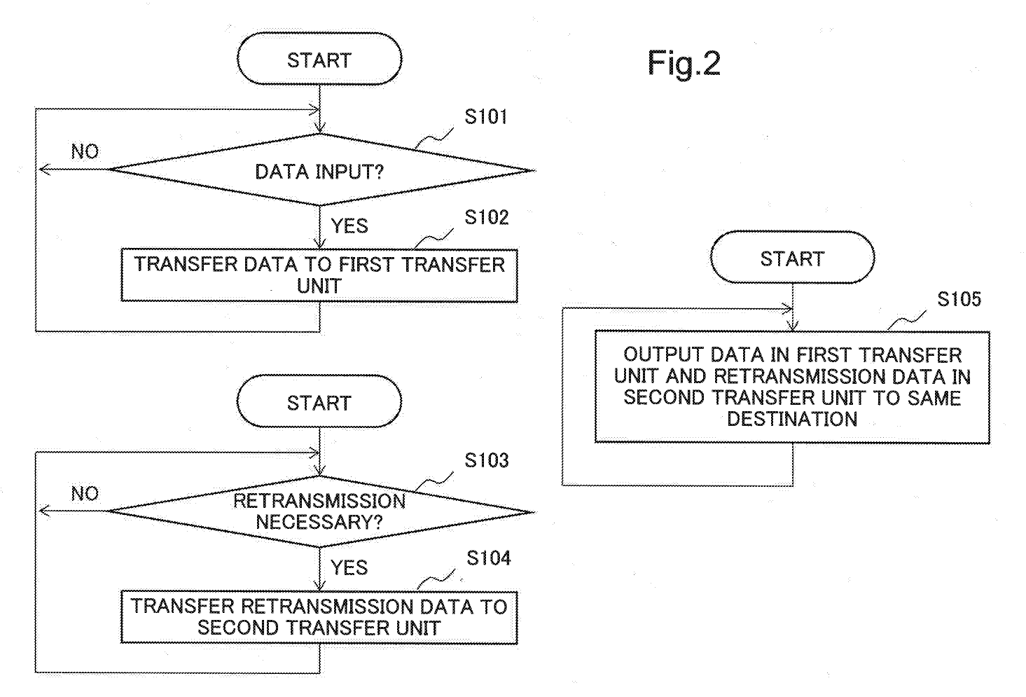

Next, in FIG. 2, an example of operation of the transmission device 10 of the present example embodiment is illustrated.

The data transmission unit 14 transfers a data piece that the data input unit 11 has input to the first transfer unit 12 (steps S101 and S102). The retransmission control unit 15 determines necessity of retransmission of a data piece, and, when the retransmission is determined to be necessary, the retransmission data transmission unit 16 transfers a retransmission data piece necessary to be retransmitted to the second transfer unit 13 (steps S103 and S104). The input/output processing unit 17, in advance of at least any of a data piece(s) remaining in the first transfer unit 12 at a point of time of transfer of a retransmission data piece to the second transfer unit 13, outputs the retransmission data piece in the second transfer unit 13 to the same destination as that of the data piece(s) in the first transfer unit 12 (step S105).

Operating in this way causes the transmission device 10 to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in a buffer in the first transfer unit 12. As a result, a delay until the output of a retransmission data piece can be reduced.

As described thus far, in the first example embodiment of the present invention, a transmission device, in advance of at least any of a data piece(s) remaining in a first transfer unit at a point of time of transfer of a retransmission data piece to a second transfer unit, outputs the retransmission data piece in the second transfer unit to the same destination as that of the data piece(s) in the first transfer unit. This configuration enables a retransmission data piece to be output earlier by use of the second transfer unit even when a lot of data pieces are contained in a buffer in the first transfer unit. As a result, a delay until the output of a retransmission data piece can be reduced.

### Second Example Embodiment

Next, a second example embodiment of the present invention will be described. In the present example embodiment, a transmission device of the first example embodiment will be described more specifically.

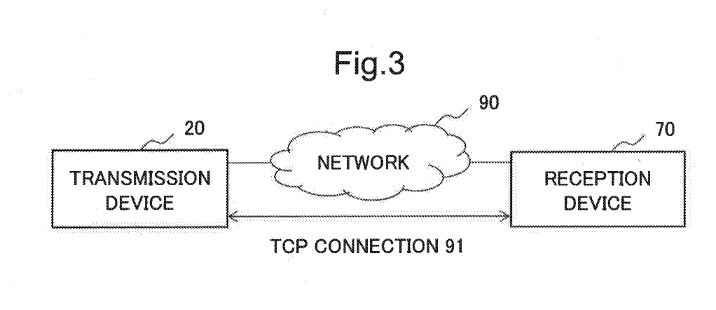

First, in FIG. 3, a configuration example of a transmission/reception system using a transmission device 20 of the present example embodiment is illustrated.

The transmission device 20 and a reception device 70 perform data transfer by use of a TCP connection 91 via a network 90. The transmission device 20 transmits a data piece to the reception device 70, and the reception device 70 replies an acknowledgment (ACK) for the data piece to the transmission device 20. There is a possibility that a data piece is lost in the network 90. It is assumed that, for example, the Internet serves as the network 90.

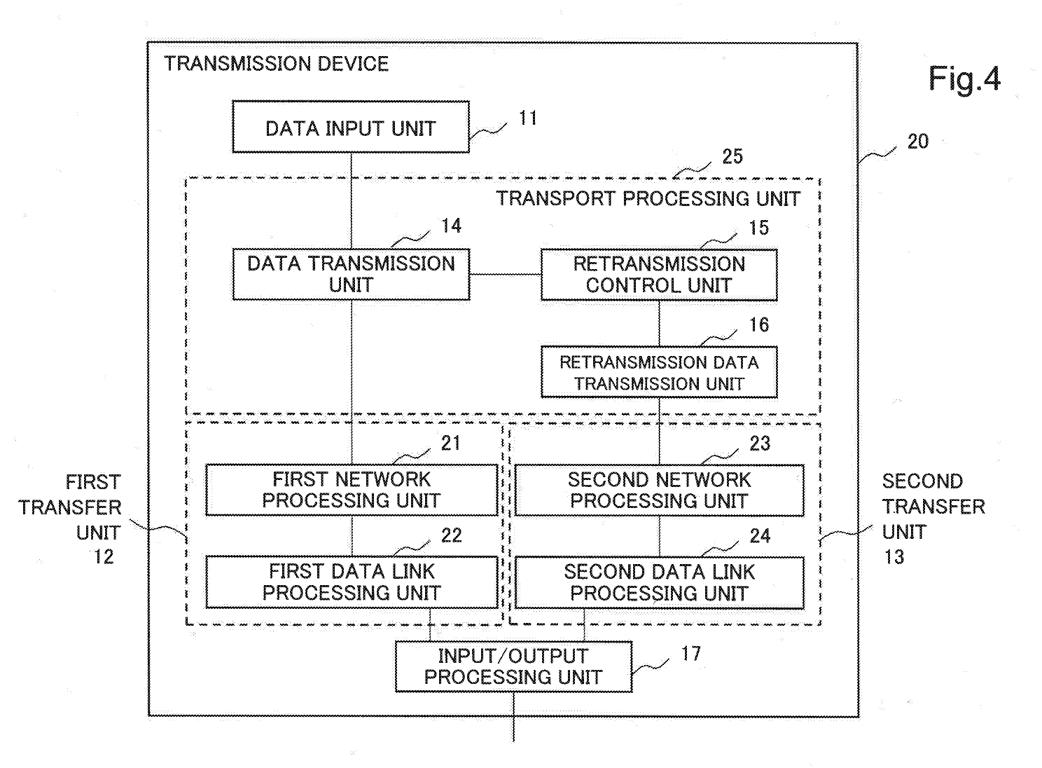

In FIG. 4, a configuration example of the transmission device 20 of the present example embodiment is illustrated. A difference from the configuration example in FIG. 1 is that the first transfer unit 12 includes a first network processing unit 21 and a first data link processing unit 22 and the second transfer unit 13 includes a second network processing unit 23 and a second data link processing unit 24. In addition, a data transmission unit 14, a retransmission control unit 15, and a retransmission data transmission unit 16 are grouped into a transport processing unit 25.

The data input unit 11 is a component that inputs data to be transmitted into the data transmission unit 14. The data input unit 11 inputs data from an application and the like into the data transmission unit 14.

The transport processing unit 25 is a component that achieves a reliable communication while accepting data from the data input unit 11, segmenting the received data into segments, and performing retransmission control. The transport processing unit 25 is a component that performs processing of a transport layer and, in the present example embodiment, performs processing of a TCP layer. The transport processing unit 25 includes the data transmission unit 14, the retransmission control unit 15, and the retransmission data transmission unit 16.

The data transmission unit 14 is a component that segments data accepted from the data input unit 11 into segments and transfers the segments to the first network processing unit 21. The data transmission unit 14 also transfers data segmented into segments to the retransmission control unit 15 for retransmission.

The retransmission control unit 15 is a component that performs retransmission control and determines necessity of retransmission of a data piece.

The retransmission data transmission unit 16 is a component that, when the retransmission control unit 15 determines that retransmission is necessary, transfers a retransmission data piece (segmentation has already been performed by the data transmission unit 14) to the second network processing unit 23.

The first network processing unit 21 is a component that encapsulates a data piece accepted from the data transmission unit 14 into a packet and hands the packet to the first data link processing unit 22. The first network processing unit 21 is a component that performs processing of a network layer and, in the present example embodiment, performs processing of an IP layer.

The first network processing unit 21 includes a first network buffer that accepts a data piece from the data transmission unit 14 and stores the accepted data piece temporarily. The data transmission unit 14 stores a data piece in the first network buffer, and the first network processing unit 21 encapsulates a data piece retrieved from the first network buffer into a packet and hands the packet to the first data link processing unit 22.

The second network processing unit 23 is a component that encapsulates a retransmission data piece accepted from the retransmission data transmission unit 16 into a packet and hands the packet to the second data link processing unit 24. The second network processing unit 23 is, as with the first network processing unit 21, also a component that performs processing of the network layer and, in the present example embodiment, performs processing of the IP layer.

The second network processing unit 23 includes a second network buffer that accepts a data piece from the retransmission data transmission unit 16 and stores the accepted data piece temporarily. The retransmission data transmission unit 16 stores a data piece in the second network buffer, and the second network processing unit 23 encapsulates a data piece retrieved from the second network buffer into a packet and hands the packet to the second data link processing unit 24.

The first data link processing unit 22 and the second data link processing unit 24 are components that encapsulate packets accepted from the first network processing unit 21 and the second network processing unit 23 into frames, respectively, and hand the frames to the input/output processing unit 17. The first data link processing unit 22 and the second data link processing unit 24 are components that perform processing of a data link layer and, in the present example embodiment, perform processing of Ethernet.

The first data link processing unit 22 includes a first data link buffer that accepts a packet from the first network processing unit 21 and stores the accepted packet temporarily. The first network processing unit 21 stores a packet in the first data link buffer, and the first data link processing unit 22 encapsulates a packet retrieved from the first data link buffer into a frame and hands the frame to the input/output processing unit 17.

The second data link processing unit 24 includes a second network buffer that accepts a packet from the second network processing unit 23 and stores the accepted packet temporarily. The second network processing unit 23 stores a packet in the second data link buffer, and the second data link processing unit 24 encapsulates a packet retrieved from the second data link buffer into a frame and hands the frame to the input/output processing unit 17.

The input/output processing unit 17 is a component that outputs a data piece accepted from each of the first data link processing unit 22 and the second data link processing unit 24 to the network 90.

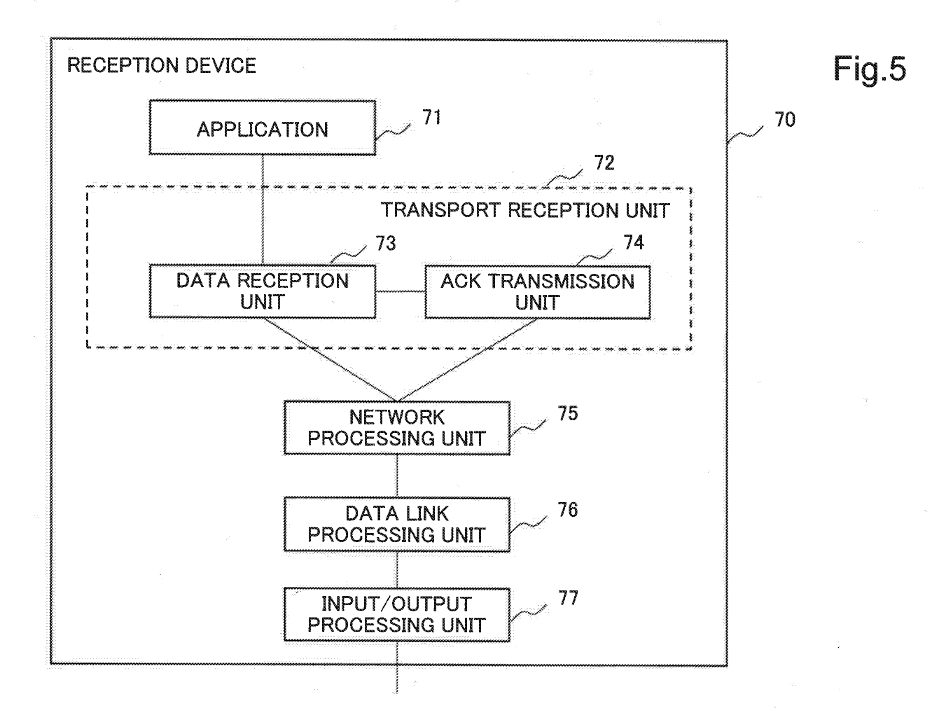

In FIG. 5, a configuration example of the reception device 70 is illustrated. The transmission device 20 of the present example embodiment is capable of communicating with the reception device 70 that achieves general TCP reception operation. Accordingly, in FIG. 5, only components required for a description of the present example embodiment will be illustrated.

The reception device 70 includes an application 71, a transport reception unit 72, a network processing unit 75, a data link processing unit 76, and an input/output processing unit 77. The transport reception unit 72 includes a data reception unit 73 and an ACK transmission unit 74.

The application 71 is a component that accepts data received by the reception device 70 and uses the accepted data.

The transport reception unit 72 is a component that transmits an ACK with respect to each segment accepted from the network processing unit 75, reconstructs data from an accepted segment(s), and hands the reconstructed data to the application 71. In the present example embodiment, the transport reception unit 72 performs data reception processing of the TCP layer.

The data reception unit 73 is a component that receives data (segments). The ACK transmission unit 74 is a component that generates and transmits an ACK with respect to each received data segment.

The network processing unit 75 is a component that decapsulates a packet received from the data link processing unit 76 into a segment and hands the segment to the data reception unit 73. In the present example embodiment, the network processing unit 75 performs data reception processing of the IP layer. The network processing unit 75 encapsulates an ACK accepted from the ACK transmission unit 74 into a packet and hands the packet to the data link processing unit 76.

The data link processing unit 76 is a component that decapsulates a signal accepted from the input/output processing unit 77 into a packet and hands the packet to the network processing unit 75. In the present example embodiment, the data link processing unit 76 performs processing of Ethernet. The data link processing unit 76 encapsulates a packet accepted from the network processing unit 75 into a frame and hands the frame to the input/output processing unit 77.

The input/output processing unit 77 is a component that converts a signal accepted from the network 90 into a frame and hands the frame to the data link processing unit 76. The input/output processing unit 77 also outputs a frame accepted from the data link processing unit 76 to the network 90.

Next, a transfer unit for retransmission (the second transfer unit 13) in the transmission device 20 of the present example embodiment will be described illustrating a correspondence relationship between processing layers and logical and physical processing units.

Some of generally available network interface cards (NIC) for Ethernet have a virtualization function. Use of this virtualization function enables an operating system (OS) to treat a physically single NIC as a plurality of NICs having a plurality of interrupt numbers. The virtualization function is originally a function for making a plurality of virtual machines operate on an OS and virtually assigning a NIC to each of the virtual machines. Use of the virtualization function of a NIC enables a transmission device of the present example embodiment to have two paths in the network layer and the data link layer and to connect to a network through one interface. This configuration enables the transmission device of the present example embodiment to be achieved even by use of a general personal computer and NIC.

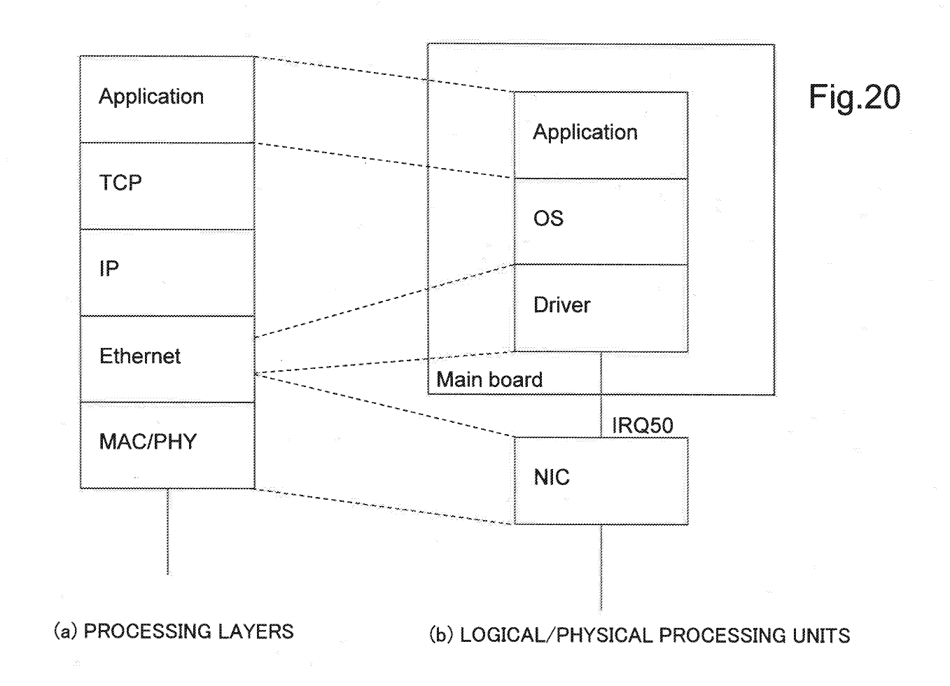

In FIG. 20, an example of an outline of a correspondence relationship between respective processing layers and logical and physical processing units in a general TCP/IP transmission device is illustrated. FIG. 20 (a) illustrates respective processing layers of TCP/IP and FIG. 20 (b) illustrates a configuration of logical and physical processing units.

In FIG. 20 (b), a main board (the body of a computer) and a NIC are connected to each other by a peripheral component interconnect (PCI) bus. A portion of processing of Ethernet is performed in an OS and drivers in the main board and another portion is performed in the NIC. A general OS includes a buffer for processing of the IP layer (sometimes including some processing of Ethernet) in a memory of a main board, and a NIC includes a buffer for processing of Ethernet.

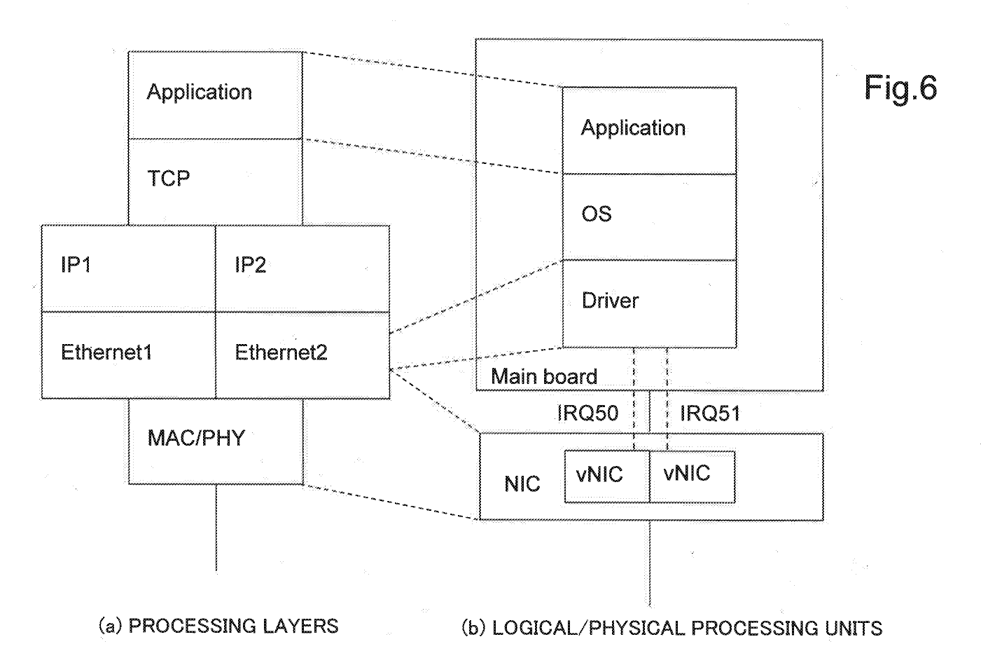

By contrast, in FIG. 6, an example of an outline of a correspondence relationship between respective processing layers and logical and physical processing units in the transmission device of the present example embodiment is illustrated. Use of the virtualization function of a NIC enables two virtual NICs (vNICs in FIG. 6) to be generated in a physical NIC, as illustrated in FIG. 6 (b). Handing a frame from each device driver of the first transfer unit 12 and the second transfer unit 13 to a corresponding one of the virtual NICs enables paths the buffers of which up to Ethernet are separated from each other to be generated.

Configuring the transmission device 20 in this way causes the transmission device 20 to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in the buffers in the first transfer unit 12. As a result, a delay until the output of a retransmission data piece can be reduced.

Next, a communication procedure between the transmission device 20 and the reception device 70 of the present example embodiment will be described. Note that, since existing TCP reception operation may be applied to operation of the reception device 70, the following description will be made mainly focusing on the transmission device 20.

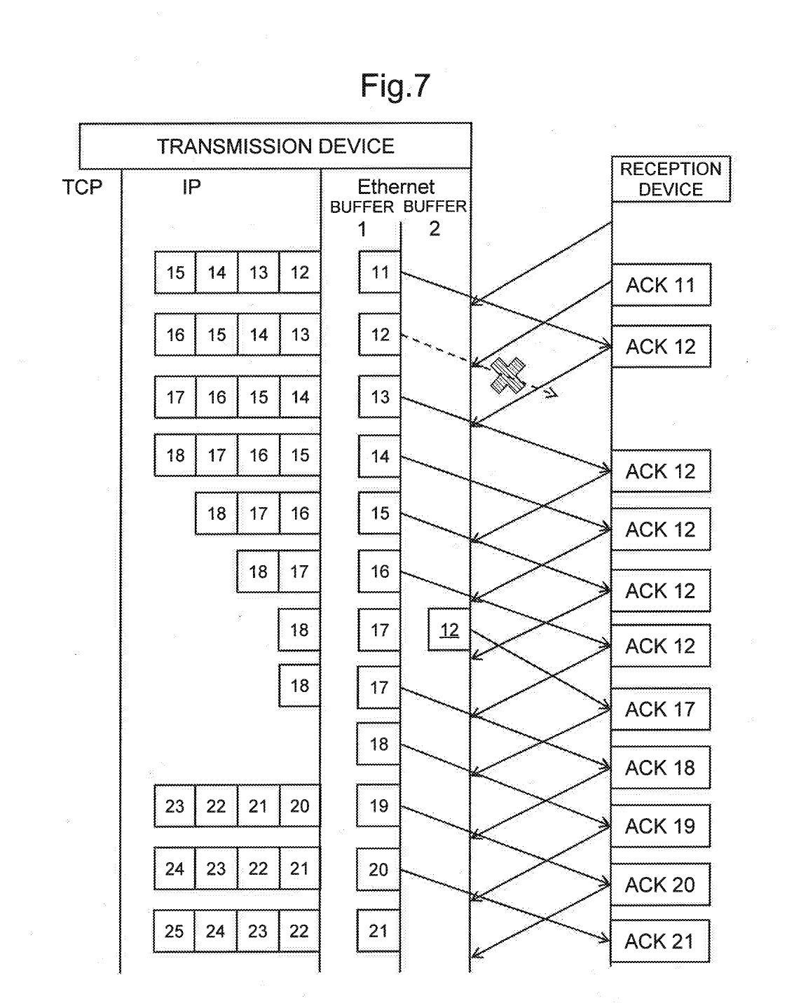

In FIG. 7, an example of data transfer using TCP/IP in the present example embodiment is illustrated. The transmission device 20 transmits a data piece to the reception device 70, and the reception device 70 replies an acknowledgment (ACK) for the data piece to the transmission device 20. While the transmission device performs communication through respective processing layers including an application layer, the TCP layer, the IP layer, and the Ethernet layer, the TCP and lower layers are illustrated in FIG. 7.

Sequence numbers are respectively provided to data pieces and ACKs. Hereinafter, sequence numbers provided to data pieces and sequence numbers provided to ACKs are referred to as data numbers and ACK numbers, respectively. In FIG. 7, transmission of data pieces with data number 11 and later that are output from the TCP layer is illustrated. For the sake of simplicity, it is assumed that the TCP layer of the transmission device is capable of transmitting data pieces up to a data piece with a data number calculated by adding 6 to the ACK number of an ACK that has been received last.

Data pieces that the TCP layer has output are buffered in each of the IP layer and the Ethernet layer and are successively output from the Ethernet layer. In FIG. 7, a data piece is transmitted with respect to each row. It is assumed that a data piece can be buffered in the Ethernet layer and six data pieces can be buffered in the IP layer. It is also assumed that the Ethernet layer is provided with a buffer 1 for a regular data piece and a buffer 2 for a retransmission data piece. Although the IP layer is also provided with two buffers, only a buffer for a regular data piece is illustrated in FIG. 7. The reception device sets a number succeeding a data number of a data piece that the reception device has just received (in other words, a data number of a data piece that the reception device expects to receive next) to an ACK number.

In the example in FIG. 7, it is assumed that a data piece 12 is lost in the network 90. When the reception device 70 receives a data piece 13, the reception device 70 replies an ACK 12 because a data piece the arrival of which the reception device 70 has expected is the data piece 12. Until the data piece 12 arrives, the reception device replies the ACK 12 when receiving a data piece other than the data piece 12.

The TCP layer of the transmission device 20 determines that the data piece 12 was lost based on the fact that three identical ACKs (ACK 12) have arrived and retransmits the data piece 12 (underlined). On this occasion, in the present example embodiment, a retransmission data piece (data piece 12) is transmitted by use of the second network processing unit 23 and the second data link processing unit 24. The data piece 12 is output from the input/output processing unit 17 in advance of data pieces 17 and 18 that have been stored in the buffer in the first network processing unit 21.

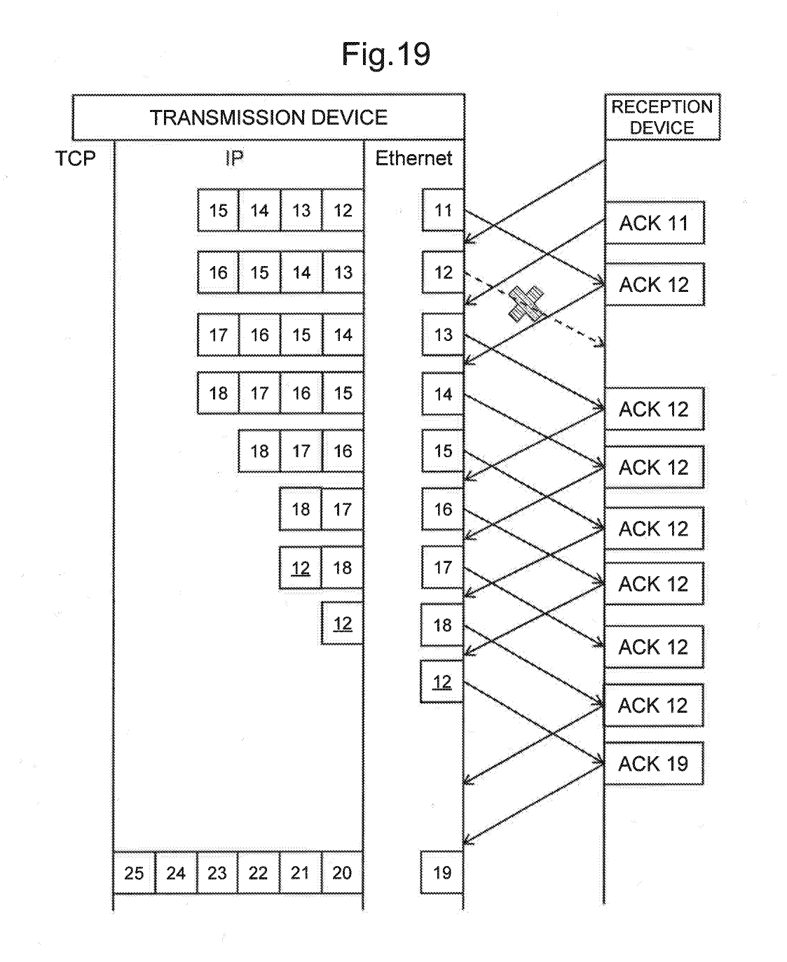

As described above, while a data piece 12 is output after data pieces 17 and 18 in an example in FIG. 19, the data piece 12 is output in advance of the data pieces 17 and 18 in the example in FIG. 7. Consequently, the transmission device 20 of the present example embodiment may reduce a delay until the output of a retransmission data piece.

In the example in FIG. 19, during a period from a point of time when the data piece 12 arrived at a reception device to a point of time when an ACK (ACK 19) that was subsequently replied arrives at a transmission device, the transmission device is in a state that there is no transmittable data. By contrast, in the example in FIG. 7, during a period from a point of time when the data piece 12 arrived at the reception device 70 to a point of time when an ACK (ACK 17) that was subsequently replied arrives at the transmission device 20, there are transmittable data (data pieces up to a data piece with a data number equal to an ACK number (12) added by 6, that is, the data pieces 17 and 18). As described above, the transmission device 20 of the present example embodiment may reduce a period of time for which transmission stops temporarily (in the case of FIG. 7, may eliminate a period of time for which transmission stops temporarily). As a result, data transfer can be performed with more stable, higher performance.

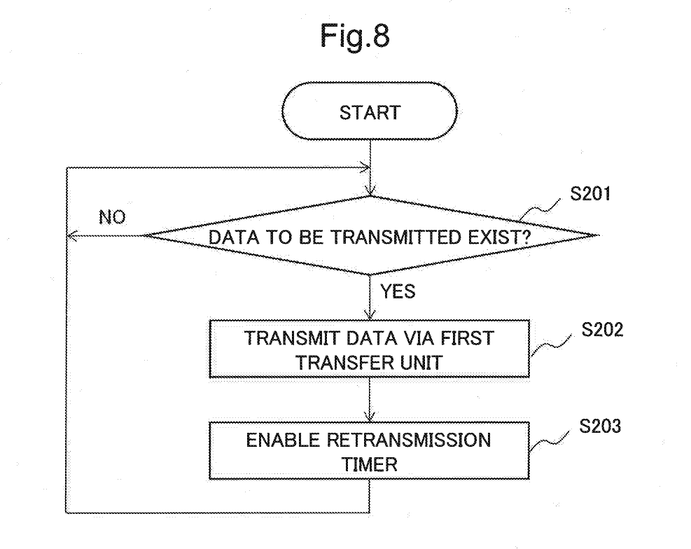

Next, in FIGS. 8 to 10, operation examples of the transmission device 20 of the present example embodiment are illustrated. Note that, since operation of the reception device 70 is similar to existing TCP reception operation, the following description will be made mainly focusing on the transmission device 20.

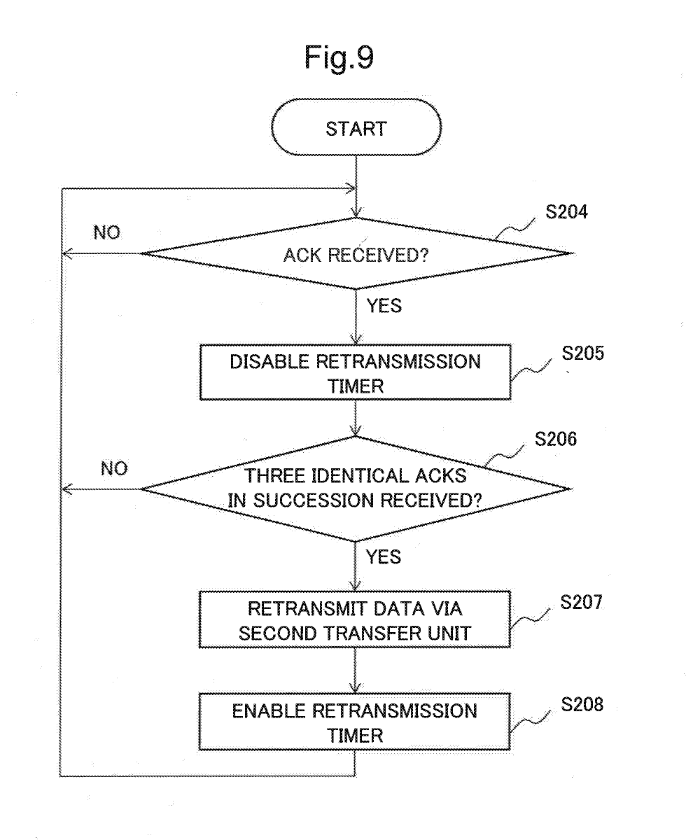

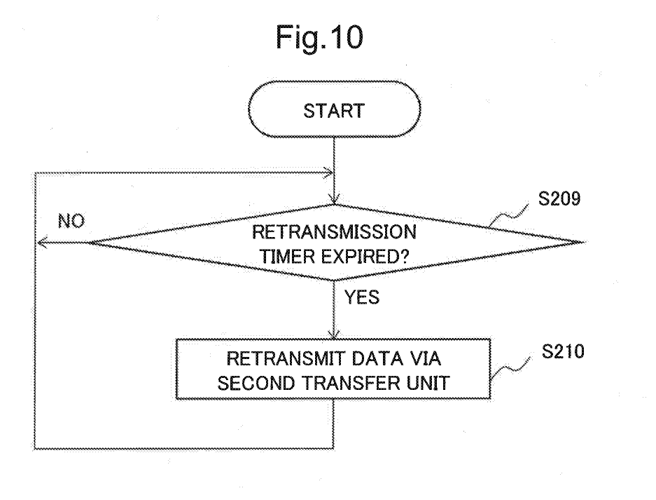

The transmission device 20 establishes a TCP connection between the transmission device 20 and the reception device 70 and, when accepting data to be transmitted to the reception device 70 from the data input unit 11 (application), starts data transmission processing. When the transmission device 20 does not have data to be transmitted to the reception device 70 and accepts a connection end instruction from the application, the transmission device 20 finishes the data transmission processing. FIGS. 8 to 10 illustrate operation examples of the transmission device 20 while the transmission device 20 performs the data transmission processing. FIG. 8 illustrates an operation example when the transmission device 20 transmits data, FIG. 9 illustrates an operation example when the transmission device 20 receives an ACK, and FIG. 10 illustrates an operation example when a retransmission timer expires.

When the data transmission unit 14 in the transmission device 20 accepts data from the data input unit 11 (YES in step S201), the data transmission unit 14 segments the data into a TCP segment(s). The data transmission unit 14 transfers a TCP segment(s) within a transmission capacity to the first transfer unit 12, based on congestion window control and an advertisement window. The first network processing unit 21 in the first transfer unit 12 encapsulates the accepted segment(s) into an IP packet(s) and transfers the IP packet(s) to the first data link processing unit 22. The first data link processing unit 22 encapsulates the accepted packet(s) into an Ethernet frame(s) and transfers the Ethernet frame(s) to the input/output processing unit 17. The input/output processing unit 17 transmits the accepted frame(s) to the reception device 70 (step S202). In step S202, each segment that is transferred from the data transmission unit 14 to the first transfer unit 12 is stored in one of the buffers in the respective layers (the network layer and the data link layer) until being output from the input/output processing unit 17.

The data transmission unit 14 transfers a segment(s) to not only the first transfer unit 12 but also the retransmission control unit 15. On this occasion, the retransmission control unit 15 enables a retransmission timer(s) (step S203). Each of the retransmission timer(s) is, for example, set at s times a round-trip time (RTT, a smoothed packet round-trip delay time). In addition, a retransmission timer is enabled for each segment.

When the retransmission control unit 15 receives an ACK from the reception device 70 via the input/output processing unit 17, the second transfer unit 13, and the retransmission data transmission unit 16 (YES in step S204), the retransmission control unit 15 disables a corresponding retransmission timer that the retransmission control unit 15 enabled in step S203 (step S205). When, as illustrated in FIG. 7, a data number of a data piece the reception of which is expected is written in each ACK as an ACK number, the retransmission control unit 15 disables a retransmission timer(s) for a segment(s) up to a segment with a number previous to the ACK number of the received ACK. For example, when the ACK number is 12, the retransmission control unit 15 disables a retransmission timer(s) for a segment(s) up to a segment with data number 11. Note that, when, in step S205, a retransmission timer has been already disabled, the retransmission control unit 15 may disable the retransmission timer again or, by determining whether or not each retransmission timer has been enabled and is counting, disable only a counting retransmission timer(s).

When the retransmission control unit 15 receives ACKs with the same ACK number consecutively three times (YES in step S206), the retransmission control unit 15 determines that retransmission is required because a data piece was lost. The retransmission data transmission unit 16 transfers a retransmission data segment corresponding to the ACK number of the received ACK to the second transfer unit 13. The second network processing unit 23 encapsulates the accepted segment into an IP packet and transfers the IP packet to the second data link processing unit 24. The second data link processing unit 24 encapsulates the accepted packet into a frame and transfers the frame to the input/output processing unit 17. The input/output processing unit 17 transmits the accepted frame to the reception device 70 (step S207). On this occasion, the retransmission control unit 15 enables a retransmission timer for the retransmitted data piece again (step S208).

When a retransmission timer expires (YES in step S209), the retransmission control unit 15 determines that retransmission of a data piece corresponding to the expired retransmission timer is required. The retransmission data transmission unit 16 retransmits a retransmission data segment containing the data piece via the second transfer unit 13 (step S210).

Operating in this way causes the transmission device 20 to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in the buffers in the first transfer unit 12. As a result, a delay until the output of a retransmission data piece can be reduced.

Next, advantageous effects of the present example embodiment will be described.

A first advantageous effect is that a transmission delay for a retransmission data piece can be reduced.

In a TCP/IP Ethernet transmission device with a general hardware configuration, a large transmission buffer causes a delay until the output of a retransmission data piece to become large. Although TCP controls retransmission of a data piece, TCP does not have a means for preferentially transmitting a retransmission data piece from a transmission device.

By contrast, a transmission device of the present example embodiment includes a first transfer unit and a second transfer unit and transmits a regular data piece by use of the first transfer unit and a retransmission data piece by use of the second transfer unit. For this reason, even when a lot of data pieces are contained in a transmission buffer in the first transfer unit, it becomes possible to output a retransmission data piece from the transmission device in advance of the data pieces in the first transfer unit. This configuration enables a transmission delay for a retransmission data piece to be reduced.

A second advantageous effect is that a transmission delay for a retransmission data piece in the data link layer can be reduced.

In a transmission device with a general configuration, since data pieces for the same destination are transmitted in the order of reception by the data link layer, a delay until the output of a retransmission data piece from the data link layer becomes large. Even when priority control is performed in the IP layer, which is a network layer, a period of time required for a retransmission data piece to be transmitted cannot be reduced because Ethernet, which is a general data link layer, does not have a mechanism for priority control.

By contrast, the transmission device of the present example embodiment includes a second data link processing unit and, using the second data link processing unit, transmits a retransmission packet. In other words, the transmission device of the present example embodiment includes a buffer for a regular data piece and a buffer for a retransmission data piece in the data link layer. This configuration enables a transmission delay for a retransmission data piece in the data link layer to be reduced.

A third advantageous effect is that even a network layer in a general transmission device can transfer a retransmission data piece to a buffer for retransmission in a data link layer.

The network layer in a general transmission device transfers data pieces addressed to the same destination to one data link layer. For this reason, even when priority control is performed in the network layer, data pieces addressed to the same destination are transferred to one data link layer, which causes a delay to occur before a retransmission data piece is transmitted by the data link layer.

By contrast, the transmission device of the present example embodiment includes a second network processing unit and the second data link processing unit and, using the second network processing unit and the second data link processing unit, transfers a retransmission data piece. In other words, the transmission device of the present example embodiment includes a buffer for a regular data piece and a buffer for a retransmission data piece in each of the network layer and the data link layer. This configuration enables even the network layer in a general transmission device to transfer a retransmission data piece from the buffer for retransmission in the network layer to the buffer for retransmission in the data link layer. In consequence, it becomes possible to reduce a transmission delay for a retransmission data piece in the data link layer.

A fourth advantageous effect is that a cost can be reduced when compared with a case in which a retransmission data piece is identified in the network layer and the data link layer.

A data piece in the network layer or the data link layer does not have information about whether or not the data piece is a retransmission packet. For this reason, in order to identify a retransmission packet in the network layer and the data link layer, it is required to refer to TCP/IP headers of all input data pieces, retrieve data pieces having relevant TCP/IP connections, and infer that a retransmission operation by TCP was performed. A retransmission operation by TCP is performed when the same ACK is transmitted three or more times, a retransmission timer expires (retransmission timeout), the transmission device is notified of a lost data piece using a selective ACK (SACK) option, or the like. The inference of an occurrence of such a retransmission operation requires a great deal of cost (computer resources, storage resources, computation time, power cost, and the like).

By contrast, in the transmission device of the present example embodiment, the transport layer sorts a retransmission data piece to the second transfer unit. For this reason, identification of a retransmission packet in the network layer and the data link layer becomes unnecessary. This configuration enables a cost to be reduced when compared with a case in which a retransmission data piece is identified in the network layer and the data link layer.

A fifth advantageous effect is that data pieces that are processed by a plurality of data link layers can be output from the same output interface (output port).

A transmission device having a general configuration outputs data pieces that went through a plurality of data link layers from a different output interface with respect to each data link layer. Therefore, a retransmission data piece that goes through the second transfer unit is caused to be output from an output interface different from an output interface for a regular data piece. Output of a retransmission data piece from an output interface different from the output interface for a regular data piece makes it difficult for a reception device to normally receive the retransmission data piece.

By contrast, the transmission device of the present example embodiment may have a configuration in which a plurality of data link layers share one output interface (output port) by, for example, using a virtualization function of a NIC. This configuration enables the transmission device to output data pieces that were processed by a plurality of data link layers from the same output interface.

As described thus far, in the second example embodiment of the present invention, a transmission device, in advance of at least any of a data piece(s) remaining in a first transfer unit at a point of time of transfer of a retransmission data piece to a second transfer unit, outputs the retransmission data piece in the second transfer unit to the same destination as that of the data piece(s) in the first transfer unit 2. This configuration enables a retransmission data piece to be output earlier by use of the second transfer unit even when a lot of data pieces are contained in buffers in the first transfer unit. As a result, a delay until the output of a retransmission data piece can be reduced.

The transmission device of the present example embodiment includes a buffer for a regular data piece and a buffer for a retransmission data piece in the data link layer. This configuration enables a transmission delay for a retransmission data piece in the data link layer to be reduced.

In addition, the transmission device of the present example embodiment includes a buffer for a regular data piece and a buffer for a retransmission data piece in each of the network layer and the data link layer. This configuration enables even a network layer in a general transmission device to transfer a retransmission data piece from the buffer for retransmission in the network layer to the buffer for retransmission in the data link layer. In consequence, it becomes possible to reduce a transmission delay for a retransmission data piece in the data link layer.

In the transmission device of the present example embodiment, the transport layer sorts a retransmission data piece to the second transfer unit. For this reason, identification of a retransmission packet in the network layer and the data link layer becomes unnecessary. This configuration enables a cost to be reduced when compared with a case in which a retransmission data piece is identified in the network layer and the data link layer.

The transmission device of the present example embodiment may have a configuration in which a plurality of data link layers share one output interface (output port) by, for example, using a virtualization function of a NIC. This configuration enables data pieces that are transmitted to a plurality of data link layers to be output from the same output interface.

### Third Example Embodiment

Next, a third example embodiment of the present invention will be described.

The second example embodiment was configured in such a way that two network processing units and two data link processing units were set up and respective transfer units included different pairs of a network processing unit and a data link processing unit. By contrast, in the present example embodiment, transfer units share one network processing unit.

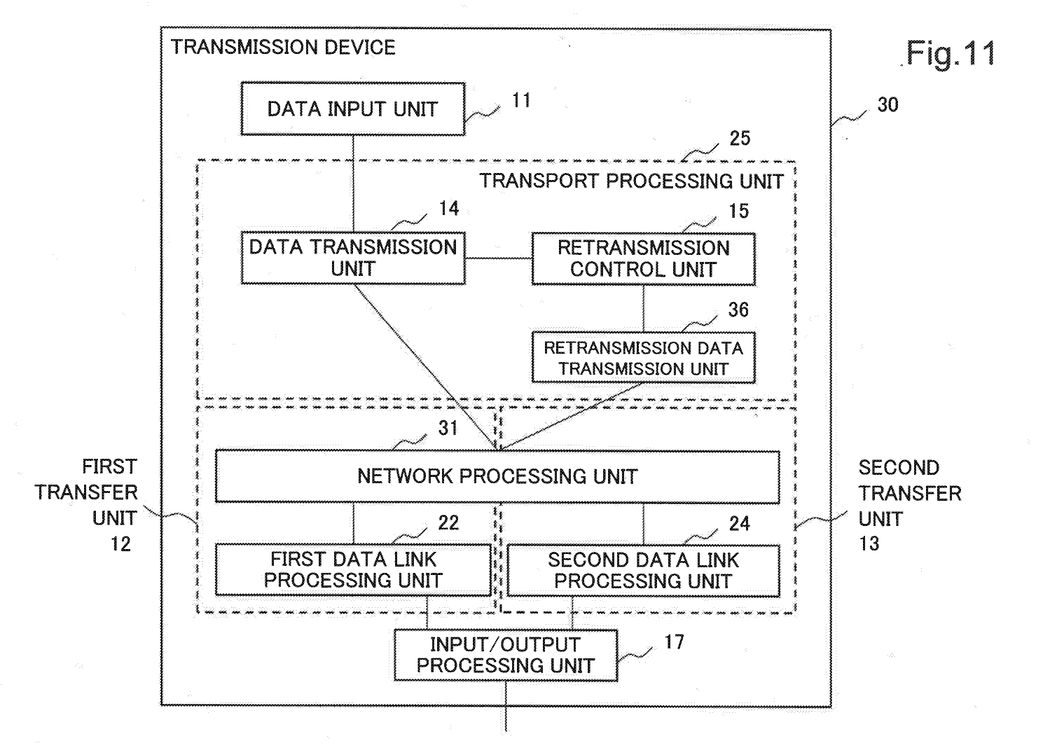

In FIG. 11, a configuration example of a transmission device 30 of the present example embodiment is illustrated. Differences from FIG. 4 are that the transmission device 30 includes only one network processing unit and includes a retransmission data transmission unit 36 instead of a retransmission data transmission unit 16. Since the other components are similar to those in FIG. 4, a description thereof will be omitted.

A difference between the retransmission data transmission unit 36 and the retransmission data transmission unit 16 is that the retransmission data transmission unit 36 provides a retransmission data segment to be transferred to a network processing unit 31 with a flag indicating that the segment is a retransmission data piece.

The network processing unit 31 accepts segments from a data transmission unit 14 and the retransmission data transmission unit 36 and encapsulates the segments into packets. The network processing unit 31 confirms a flag of each segment and transfers a regular data piece to a first data link processing unit 22 and a retransmission data piece to a second data link processing unit 24, respectively.

Configuring the transmission device 30 in this way causes the transmission device 30 to, in advance of at least any of a data piece(s) remaining in a first transfer unit 12 at a point of time of transfer of a retransmission data piece to a second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in buffers in the first transfer unit 12. As a result, a delay until the output of a retransmission data piece can be reduced.

When a transmission device of the present example embodiment transfers a retransmission data piece from a transport layer to a network layer, the transmission device provides the retransmission data piece with a flag indicating that the data piece is a retransmission data piece. The network layer confirms the flag and, when the data is a retransmission data piece, transfers the data piece to a data link layer for retransmission. For this reason, it becomes possible to sort a regular data piece and a retransmission data piece to the two data link layers even when only one network layer processes the data pieces. This configuration enables a transmission delay for a retransmission data piece in the data link layer to be reduced.

In the transmission device of the present example embodiment, the respective transfer units share one network processing unit. This configuration enables hardware resources that the transmission device uses to be reduced when compared with a case in which the transmission device includes two network processing units.

Next, using FIGS. 8 to 10 and 12, operation examples of the transmission device 30 of the present example embodiment will be described.

When the retransmission data transmission unit 36 transfers a segment containing a retransmission data in step S207 in FIG. 9 and step S210 in FIG. 10, the retransmission data transmission unit 36 provides the retransmission segment with a flag indicating that the segment is a retransmission data piece. The network processing unit 31 confirms a flag of each segment in step S202 in FIG. 8, step S207 in FIG. 9, and step S210 in FIG. 10 and transfers a regular data piece to the first data link processing unit 22 and a retransmission data piece to the second data link processing unit 24.

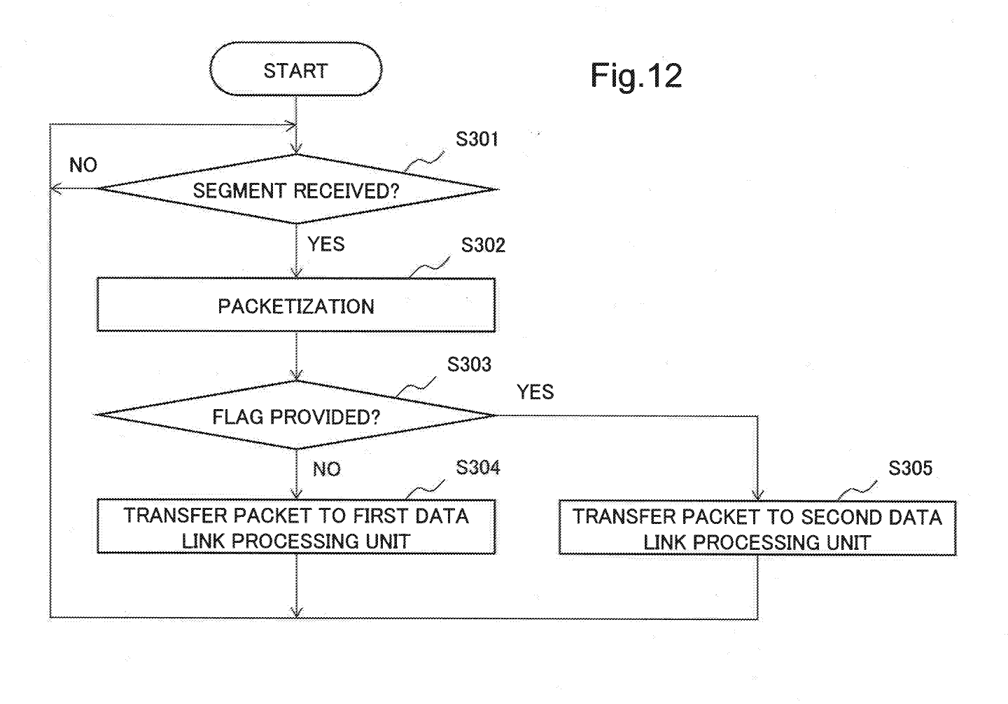

In FIG. 12, an example of operation of the network processing unit 31 in step S202 in FIG. 8, step S207 in FIG. 9, and step S210 in FIG. 10 is illustrated.

When the network processing unit 31 accepts a segment from the data transmission unit 14 or the retransmission data transmission unit 36 (step S301), the network processing unit 31 encapsulates the segment into a packet (step S302). When a flag indicating that the segment is a retransmission data piece is not provided to the segment (NO in step S303), the network processing unit 31 transfers the packet to the first data link processing unit 22 (step S304). When a flag indicating that the segment is a retransmission data piece is provided to the segment, the network processing unit 31 transfers the packet to the second data link processing unit 24 (step S305).

Operating in this way causes the transmission device 30 to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in buffers in the first transfer unit 12. As a result, a delay until the output of a retransmission data piece can be reduced.

As described thus far, in the third example embodiment of the present invention, as with the first and second example embodiments, a transmission device, in advance of at least any of a data piece(s) remaining in a first transfer unit at a point of time of transfer of a retransmission data piece to a second transfer unit, outputs the retransmission data piece in the second transfer unit to the same destination as that of the data piece(s) in the first transfer unit. This configuration enables a retransmission data piece to be output earlier by use of the second transfer unit even when a lot of data pieces are contained in buffers in the first transfer unit. As a result, a delay until the output of a retransmission data piece can be reduced.

When the transmission device of the present example embodiment transfers a retransmission data piece from the transport layer to the network layer, the transmission device provides the retransmission data piece with a flag indicating that the data piece is a retransmission data piece. The network layer confirms the flag and transfers the retransmission data piece to the data link layer for retransmission. For this reason, it becomes possible to sort a regular data piece and a retransmission data piece to two data link layers even when only one network layer processes the data pieces. This configuration enables a transmission delay for a retransmission data piece in the data link layer to be reduced.

In the transmission device of the present example embodiment, the respective transfer units share one network processing unit. This configuration enables hardware resources that the transmission device uses to be reduced when compared with a case in which the transmission device includes two network processing units.

### Fourth Example Embodiment

Next, a fourth example embodiment of the present invention will be described.

The second example embodiment was configured in such a way that two network processing units and two data link processing units were set up and respective transfer units included different pairs of a network processing unit and a data link processing unit. In the third example embodiment, respective transfer units shared one network processing unit. By contrast, in the present example embodiment, respective transfer units share one data link processing unit.

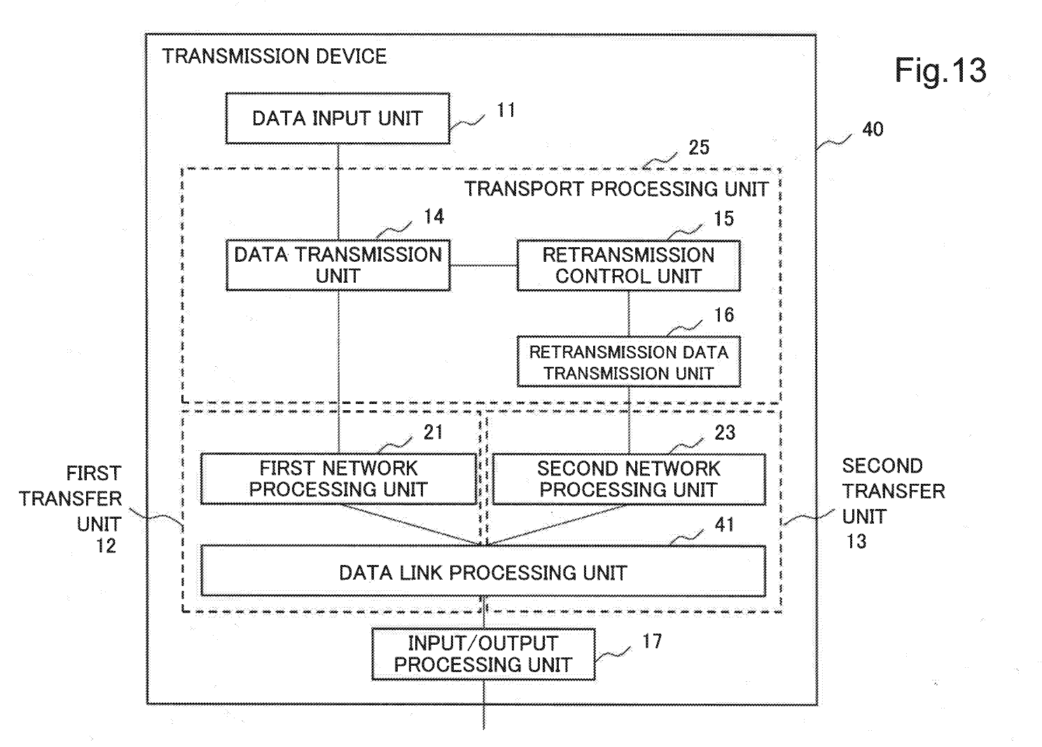

In FIG. 13, a configuration example of a transmission device 40 of the present example embodiment is illustrated. A difference from FIG. 4 is that the transmission device 40 includes only one data link processing unit. Since the other components are similar to those in FIG. 4, a description thereof will be omitted.

A data link processing unit 41 accepts packets from a first network processing unit 21 and a second network processing unit 23 and encapsulates the packets into frames. The data link processing unit 41 transfers the framed data pieces to an input/output processing unit 17.

Configuring the transmission device 40 in this way causes the transmission device 40 to, in advance of at least any of a data piece(s) remaining in a first transfer unit 12 at a point of time of transfer of a retransmission data piece to a second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in buffers in the first transfer unit 12. As a result, a delay until the output of a retransmission data piece can be reduced.

A transmission device of the present example embodiment includes two network processing units. This configuration enables a transmission delay for a retransmission data piece in the network layer to be reduced.

In the transmission device of the present example embodiment, the respective transfer units share one data link processing unit. This configuration enables hardware resources that the transmission device uses to be reduced when compared with a case in which the transmission device includes two data link processing units.

Next, using FIGS. 8 to 10, operation examples of the transmission device 40 of the present example embodiment will be described.

In step S202 in FIG. 8, a data transmission unit 14 transfers a data piece to the first network processing unit 21. The first network processing unit 21, which accepted the data piece, transfers the data piece to the data link processing unit 41. The data link processing unit 41 outputs the data piece via the input/output processing unit 17.

In step S207 in FIG. 9 and step S210 in FIG. 10, a retransmission data transmission unit 16 transfers a retransmission data piece to the second network processing unit 23. The second network processing unit 23, which accepted the retransmission data piece, transfers the data piece to the data link processing unit 41. The data link processing unit 41 outputs the data piece via the input/output processing unit 17.

Operating in this way causes the transmission device 40 to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in buffers in the first transfer unit 12. As a result, a delay until the output of a retransmission data piece can be reduced.

As described thus far, in the fourth example embodiment of the present invention, as with the first to third example embodiments, a transmission device, in advance of at least any of a data piece(s) remaining in a first transfer unit at a point of time of transfer of a retransmission data piece to a second transfer unit, outputs the retransmission data piece in the second transfer unit to the same destination as that of the data piece(s) in the first transfer unit. This configuration enables a retransmission data piece to be output earlier by use of the second transfer unit even when a lot of data pieces are contained in buffers in the first transfer unit. As a result, a delay until the output of a retransmission data piece can be reduced.

The transmission device of the present example embodiment includes two network processing units. This configuration enables a transmission delay for a retransmission data piece in the network layer to be reduced.

In the transmission device of the present example embodiment, the respective transfer units share one data link processing unit. This configuration enables hardware resources that the transmission device uses to be reduced when compared with a case in which the transmission device includes two data link processing units.

### Fifth Example Embodiment

Next, a fifth example embodiment of the present invention will be described. The present example embodiment is an embodiment in which, when two network processing units are set up, a transfer condition for a communication flow in a first network processing unit 21 and a transfer condition for a communication flow in a second network processing unit 23 are made identical to each other.

Generally, in an IP layer, a packet filter is set according to a state of a communication session and is configured to allow only a packet of a TCP connection that is normally established to pass in order to improve safety in service and communication. For this reason, when a second transfer unit 13 is used, processing states of such packet filters set for a first transfer unit 12 and the second transfer unit 13 are sometimes required to be made identical to each other. In the present example embodiment, an embodiment in which transfer conditions for communication flows, such as processing states of packet filters, in the first transfer unit 12 and the second transfer unit 13 are made identical to each other will be described.

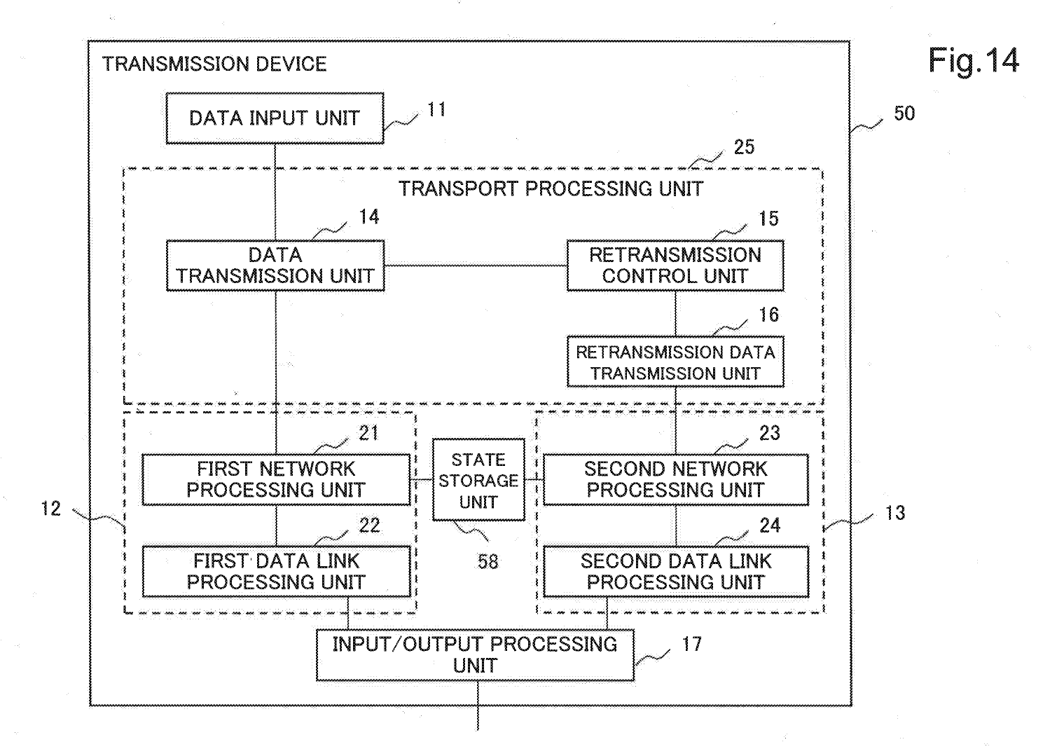

In FIG. 14, a configuration example of a transmission device 50 of the present example embodiment is illustrated. A state storage unit 58 is added to a configuration in FIG. 4. The state storage unit 58 may be added to a configuration in FIG. 13.

The state storage unit 58 is a unit that stores a transfer condition for a communication flow, such as a processing state of a packet filter, in each of the first network processing unit 21 and the second network processing unit 23. The first network processing unit 21 and the second network processing unit 23 sharing the state storage unit 58 enables the first network processing unit 21 and the second network processing unit 23 to make transfer conditions thereof coincide with each other. In the state storage unit 58, for example, an IP address and a port number with respect to a connection that allows packets to pass can be stored.

Configuring the transmission device 50 in this way causes the transmission device 50 to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in buffers in the first transfer unit 12. As a result, a delay until the output of a retransmission data piece can be reduced.

A transmission device of the present example embodiment has a state storage unit set up among a plurality of network layers and synchronizes transfer conditions in the plurality of network layers with one another. Even when a plurality of network layers are used, this configuration enables transfer conditions in the respective network layers to be synchronized with one another so that inconsistency does not occur in processing.

The transmission device of the present example embodiment has a state storage unit set up between two network layers and synchronizes processing states of packet filters with each other. This configuration enables processing states of dynamic filters that are set according to a communication state to be made identical to each other between the two network layers, which enables normal communication to be performed.

Next, an operation example of the transmission device 50 of the present example embodiment will be described.

Every time each of the first network processing unit 21 and the second network processing unit 23 changes a transfer condition for a communication flow, such as a processing state of a dynamic filter, the each of the first network processing unit 21 and the second network processing unit 23 stores the changed transfer condition in the state storage unit 58. When each of the first network processing unit 21 and the second network processing unit 23 performs transfer processing such as filtering, the each of the first network processing unit 21 and the second network processing unit 23 performs the transfer processing referring to the transfer condition stored in the state storage unit 58.

Operating in this way causes the transmission device 50 to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in buffers in the first transfer unit 12. As a result, a delay until the output of a retransmission data piece can be reduced.

As described thus far, in the fifth example embodiment of the present invention, as with the first to third example embodiments, a transmission device, in advance of at least any of a data piece(s) remaining in a first transfer unit at a point of time of transfer of a retransmission data piece to a second transfer unit, outputs the retransmission data piece in the second transfer unit to the same destination as that of the data piece(s) in the first transfer unit. This configuration enables a retransmission data piece to be output earlier by use of the second transfer unit even when a lot of data pieces are contained in buffers in the first transfer unit. As a result, a delay until the output of a retransmission data piece can be reduced.

The transmission device of the present example embodiment has a state storage unit set up among a plurality of network layers and synchronizes transfer conditions in the plurality of network layers with one another. Even when a plurality of network layers are used, this configuration enables transfer conditions in the respective network layers to be synchronized with one another so that inconsistency does not occur in processing.

The transmission device of the present example embodiment has a state storage unit set up between two network layers and synchronizes processing states of packet filters with each other. This configuration enables processing states of dynamic filters that are set according to a communication state to be made identical to each other between the two network layers, which enables normal communication to be performed.

### Sixth Example Embodiment

Next, a sixth example embodiment of the present invention will be described. The present example embodiment is an embodiment in which the number of data pieces that a retransmission data piece has overtaken is measured.

Even when priority control of a retransmission data piece using a second transfer unit is introduced to the transmission device as in the first to fifth example embodiments, it is difficult for users to grasp an effect of the introduction of priority control unless the number of data pieces that a retransmission data piece has overtaken is obtained. Therefore, in the present example embodiment, a transmission device measuring the number of data pieces that a retransmission data piece has overtaken due to priority control enables users to grasp an effect of the introduction of the priority control. There is also a possibility that this capability clarifies an investment effect in the priority control, as a result of which a degree of satisfaction of users may be improved.

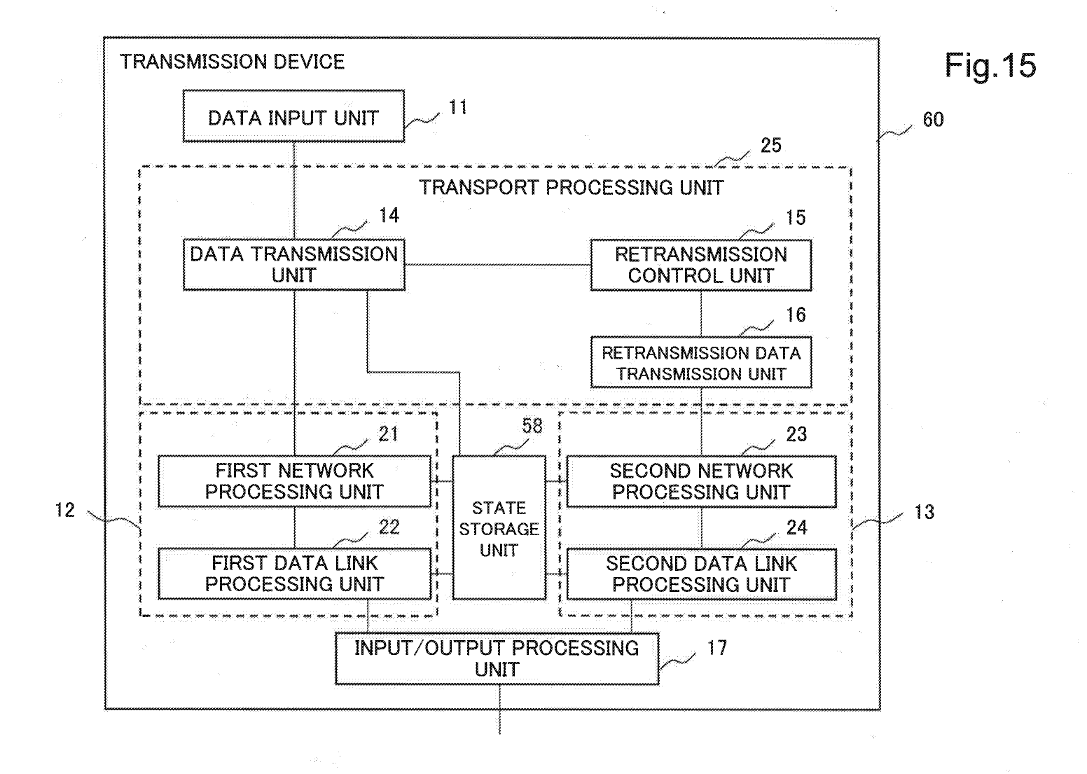

In FIG. 15, a configuration example of a transmission device 60 of the present example embodiment is illustrated. In FIG. 15, a state storage unit 58 is added to a configuration in FIG. 4. The state storage unit 58 may be added to a configuration example in FIG. 11 or 13.

In the present example embodiment, calculation of the number of overtaken data pieces is performed by a second network processing unit 23 or a second data link processing unit 24.

When the calculation of the number of overtaken data pieces is performed by the second network processing unit 23, the number of data pieces to be calculated is equal to the number of data pieces that a retransmission data piece has overtaken in a network layer and does not include the number of data pieces that the retransmission data piece has overtaken in a data link layer.

When the calculation of the number of overtaken data pieces is performed by the second data link processing unit 24, the number of data pieces that a retransmission data piece has overtaken in the data link layer or the sum of the number of data pieces that the retransmission data piece has overtaken in the network layer and the number of data pieces that the retransmission data piece has overtaken in the data link layer can be calculated.

First, a case in which the calculation of the number of overtaken data pieces is performed by the second network processing unit 23 will be described.

When a first network processing unit 21 transfers a data packet to the data link layer, the first network processing unit 21 stores a data number (TCP sequence number) of the data packet in the state storage unit 58. The data number (first data number) is a data number of a last data packet that has been transferred to the data link layer.

When a data transmission unit 14 transfers a data piece to the first network processing unit 21, the data transmission unit 14 stores a data number (second data number) of the data piece in the state storage unit 58. The second data number is a largest data number among a data number(s) of a data piece(s) stored in a buffer in the first network processing unit 21.

When the second network processing unit 23 transfers a retransmission data piece to the data link layer, the second network processing unit 23 calculates the number of data pieces that the retransmission data piece has overtaken in the network layer, based on the first data number and the second data number stored in the state storage unit 58.

For example, in the case of an example in FIG. 7, the number of data pieces stored in the IP layer is calculated by subtracting the first data number from the second data number. When a retransmission data piece with data number 12 is transferred from the IP layer to the Ethernet layer, the first data number and the second data number that the state storage unit 58 stores are 17 and 18, respectively. At this time, the number of data pieces stored in the IP layer is calculated by subtracting the first data number from the second data number to be 1, which is the number of data pieces that the retransmission data piece with the data number 12 has overtaken.

Next, a case in which the calculation of the number of overtaken data pieces in the data link layer is performed by the second data link processing unit 24 will be described.

When a first data link processing unit 22 transfers a data packet to an input/output processing unit 17, the first data link processing unit 22 stores a data number (TCP sequence number) (third data number) of the data packet in the state storage unit 58. The third data number is a data number of a last data packet that has been transferred from the first data link processing unit 22 to the input/output processing unit 17.

When the first network processing unit 21 (or a network processing unit 31) transfers a data piece to the first data link processing unit 22, the first network processing unit 21 stores a data number (first data number) of the data piece in the state storage unit 58. The first data number is a data number of a last data piece that has been transferred to the data link layer and, in this case, a largest data number among a data number(s) of a data piece(s) stored in a buffer in the first data link processing unit 22.

When the second data link processing unit 24 transfers a retransmission data piece to the input/output processing unit 17, the second data link processing unit 24 calculates the number of data pieces that the retransmission data piece has overtaken in the data link layer, based on the third data number and the first data number stored in the state storage unit 58.

For example, in the case of the example in FIG. 7, the number of data pieces stored in a buffer 1 in the Ethernet layer is calculated by subtracting the third data number from the first data number. When the retransmission data piece with the data number 12 is transferred from a buffer 2 in the Ethernet layer to the input/output processing unit, the third data number and the first data number that the state storage unit 58 stores are 16 and 17, respectively. At this time, the number of data pieces stored in the buffer 1 in the Ethernet layer is calculated by subtracting the third data number from the first data number to be 1, which is the number of data pieces that the retransmission data piece with the data number 12 has overtaken in the data link layer.

Next, a case in which the calculation of the sum of the number of data pieces that have been overtaken in the network layer and the number of data pieces that have been overtaken in the data link layer is performed by the second data link processing unit 24 will be described.

When the first data link processing unit 22 transfers a data packet to the input/output processing unit 17, the first data link processing unit 22 stores a data number (TCP sequence number) (third data number) of the data packet in the state storage unit 58. The third data number is a data number of a last data packet that has been transferred from the first data link processing unit 22 to the input/output processing unit 17.

When the data transmission unit 14 transfers a data piece to the first network processing unit 21, the data transmission unit 14 stores a data number (second data number) of the data piece in the state storage unit 58. The second data number is a largest data number among a data number(s) of a data piece(s) stored in the buffer in the first network processing unit 21.

When the second data link processing unit 24 transfers a retransmission data piece to the input/output processing unit 17, the second data link processing unit 24 calculates the sum of the numbers of data pieces that have been overtaken in the data link layer and the network layer, based on the third data number and the second data number stored in the state storage unit 58.

For example, in the case of the example in FIG. 7, the sum of the numbers of data pieces stored in the network layer and the buffer 1 in the Ethernet layer is calculated by subtracting the third data number from the second data number. When the retransmission data piece with the data number 12 is transferred from the buffer 2 in the Ethernet layer to the input/output processing unit, the third data number and the second data number that the state storage unit 58 stores are 16 and 18, respectively. At this time, the sum of the numbers of data pieces stored in the buffer 1 in the Ethernet layer and the IP layer is calculated by subtracting the third data number from the second data number to be 2, which is the number of data pieces that the retransmission data piece with the data number 12 has overtaken in the data link layer and the network layer.

Configuring the transmission device in this way causes the transmission device to, in advance of at least any of a data piece(s) remaining in a first transfer unit 12 at a point of time of transfer of a retransmission data piece to a second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in the buffers in the first transfer unit 12. As a result, a delay until the output of a retransmission data piece can be reduced.

The transmission device of the present example embodiment calculates the number of data pieces that a retransmission data piece has overtaken from data numbers stored in a state storage unit. This configuration enables users to grasp an effect of introduction of priority control.

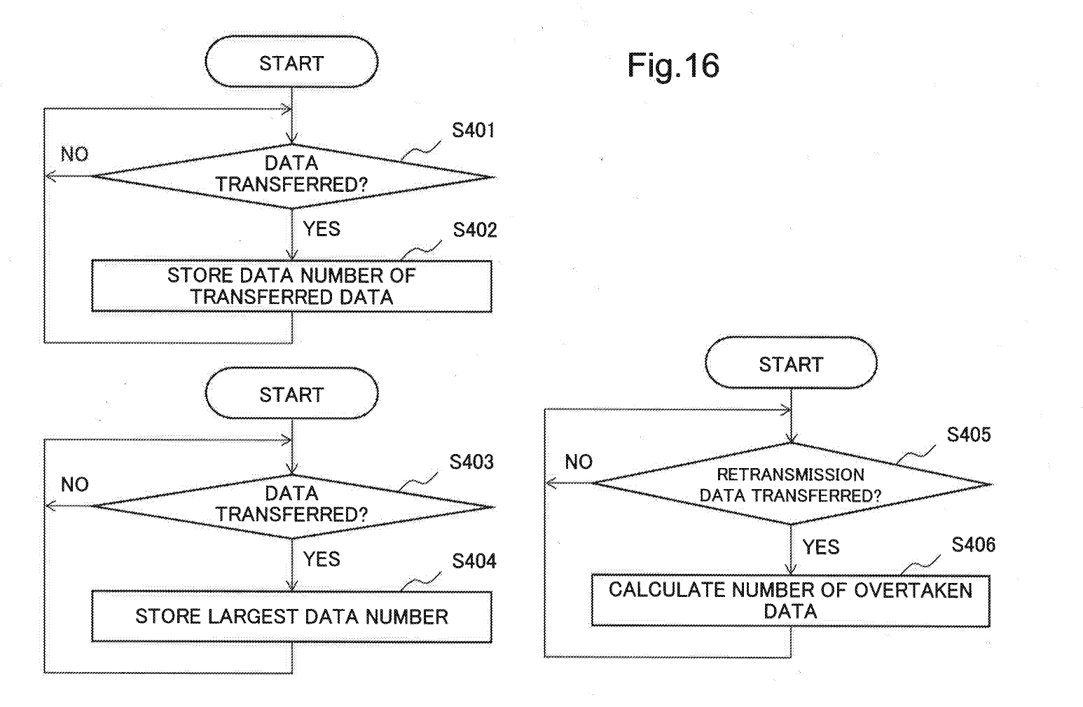

Next, in FIG. 16, an operation example of overtaken data count calculation operation performed by the transmission device 60 of the present example embodiment is illustrated. Since transfer operation of a retransmission data piece is similar to those described in the first to fifth example embodiments, a description thereof will be omitted.

First, an example of calculation operation of the number of data pieces that have been overtaken in the network layer will be described.

First, when the first network processing unit 21 transfers a data piece to the data link layer (YES in step S401), the first network processing unit 21 stores a data number (first data number) of the data piece in the state storage unit 58 (step S402). The first data number is a data number of a last data piece that has been transferred from the first network processing unit 21.

When the data transmission unit 14 transfers a data piece to the first network processing unit 21 (YES in step S403), the data transmission unit 14 stores a data number (second data number) of the data piece in the state storage unit 58 (step S404). The second data number is a largest data number among a data number(s) of a data piece(s) stored in the buffer in the first network processing unit 21.

When the second network processing unit 23 transfers a retransmission data piece to the data link layer (YES in step S405), the second network processing unit 23 calculates the number of data pieces that have been overtaken, based on the first data number and the second data number stored in the state storage unit 58 (step S406).

Next, an example of calculation operation of the number of data pieces that have been overtaken in the data link layer will be described.

First, when the first data link processing unit 22 transfers a data piece to the input/output processing unit 17 (YES in step S401), the first data link processing unit 22 stores a data number (third data number) of the data piece in the state storage unit 58 (step S402). The third data number is a data number of a last data piece that has been transferred from the first data link processing unit 22.

When the first network processing unit 21 or the network processing unit 31 transfers a data piece to the first data link processing unit 22 (YES in step S403), the first network processing unit 21 or the network processing unit 31 stores a data number (first data number) of the data piece in the state storage unit 58 (step S404). The first data number is a largest data number among a data number(s) of a data piece(s) stored in the buffer in the first data link processing unit 22.

When the second data link processing unit 24 transfers a retransmission data piece to the input/output processing unit 17 (YES in step S405), the second data link processing unit 24 calculates the number of data pieces that have been overtaken, based on the third data number and the first data number stored in the state storage unit 58 (step S406).

Next, an example of calculation operation of the sum of the numbers of data pieces that have been overtaken in the data link layer and the network layer will be described.

First, when the first data link processing unit 22 transfers a data piece to the input/output processing unit 17 (YES in step S401), the first data link processing unit 22 stores a data number (third data number) of the data piece in the state storage unit 58 (step S402). The third data number is a data number of a last data piece that has been transferred from the first data link processing unit 22.

When the data transmission unit 14 transfers a data piece to the first network processing unit 21 (YES in step S403), the data transmission unit 14 stores a data number (second data number) of the data piece in the state storage unit 58 (step S404). The second data number is a largest data number among a data number(s) of a data piece(s) stored in the buffer in the first network processing unit 21.

When the second data link processing unit 24 transfers a retransmission data piece to the input/output processing unit 17 (YES in step S405), the second data link processing unit 24 calculates the number of data pieces that have been overtaken, based on the third data number and the second data number stored in the state storage unit 58 (step S406).

Operating in this way causes the transmission device to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in the buffers in the first transfer unit 12. As a result, a delay until the output of a retransmission data piece can be reduced.

As described thus far, in the sixth example embodiment of the present invention, as with the first to fifth example embodiments, a transmission device, in advance of at least any of a data piece(s) remaining in a first transfer unit at a point of time of transfer of a retransmission data piece to a second transfer unit, outputs the retransmission data piece in the second transfer unit to the same destination as that of the data piece(s) in the first transfer unit. This configuration enables a retransmission data piece to be output earlier by use of the second transfer unit even when a lot of data pieces are contained in buffers in the first transfer unit. As a result, a delay until the output of a retransmission data piece can be reduced.

The transmission device of the present example embodiment calculates the number of data pieces that a retransmission data piece has overtaken from data numbers stored in a state storage unit. This configuration enables users to grasp an effect of introduction of priority control.

### Seventh Example Embodiment

Next, a seventh example embodiment of the present invention will be described. The present example embodiment is an embodiment in which a number in accordance with a predetermined rule is provided to each output data piece in an input/output processing unit.

In the first to sixth example embodiments, a data piece output from the first network processing unit 21 and a retransmission data piece output from the second network processing unit 23 do not have consecutive packet numbers. However, some of reception devices assume that consecutive packet numbers are provided to received data. For example, such reception devices include a reception device that, assuming that a consecutive number is contained in an identifier field (IP identification (IPID)) in an IP header, infers a loss of a data piece, based on IPIDs. For this reason, in the present example embodiment, a number in accordance with a predetermined rule, for example, a consecutive number, is provided to each output data piece in the input/output processing unit.

First, a configuration example of a transmission device of the present example embodiment will be described. The configuration example of the transmission device of the present example embodiment is similar to those in the first to sixth example embodiments (FIGS. 1, 4, 11, 14, and 15).

An input/output processing unit 17 accepts data frames from a first transfer unit 12 and a second transfer unit 13, provides the accepted frames with numbers in accordance with a predetermined rule, and outputs the frames to a reception device. For example, the input/output processing unit 17 rewrites IPIDs in the IP headers of accepted frames to consecutive numbers.

Configuring the transmission device in this way causes the transmission device to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in buffers in the first transfer unit 12. As a result, a delay until the output of a retransmission data piece can be reduced.

The transmission device of the present example embodiment provides each output data piece with a number in accordance with a predetermined rule in the input/output processing unit. This configuration enables a data piece provided with a number in accordance with a predetermined rule to be output.

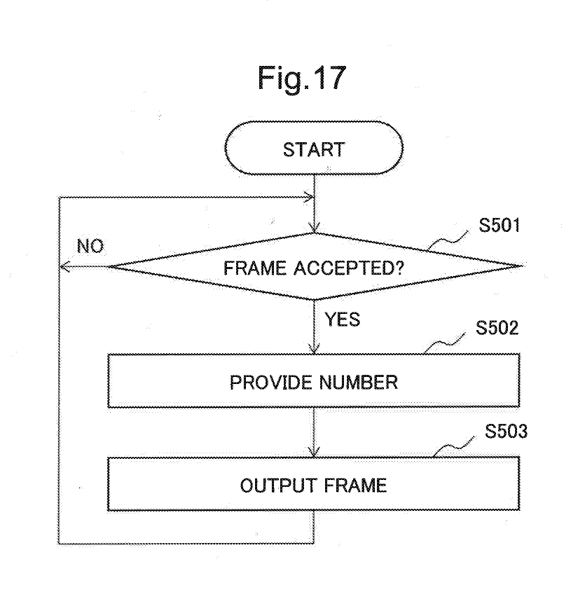

Next, using FIG. 17, an operation example of the input/output processing unit 17 of the transmission device of the present example embodiment will be described. Since operation of components other than the input/output processing unit 17 is similar to that described in the first to sixth example embodiments, a description thereof will be omitted.

When the input/output processing unit 17 accepts a data frame from the first transfer unit 12 or the second transfer unit 13 (YES in step S501), the input/output processing unit 17 provides the frame with a number in accordance with a predetermined rule (step S502). For example, the input/output processing unit 17 rewrites the IPID in the IP header of the frame to a consecutive number. The input/output processing unit 17 outputs the frame to the reception device (step S503).

Operating in this way causes the transmission device to, in advance of at least any of a data piece(s) remaining in the first transfer unit 12 at a point of time of transfer of a retransmission data piece to the second transfer unit 13, output the retransmission data piece in the second transfer unit 13 to the same destination as that of the data piece(s) in the first transfer unit 12. This configuration enables a retransmission data piece to be output earlier by use of the second transfer unit 13 even when a lot of data pieces are contained in the buffers in the first transfer unit 12. As a result, a delay until the output of a retransmission data piece can be reduced.

As described thus far, in the seventh example embodiment of the present invention, as with the first to sixth example embodiments, a transmission device, in advance of at least any of a data piece(s) remaining in a first transfer unit at a point of time of transfer of a retransmission data piece to a second transfer unit, outputs the retransmission data piece in the second transfer unit to the same destination as that of the data piece(s) in the first transfer unit. This configuration enables a retransmission data piece to be output earlier by use of the second transfer unit even when a lot of data pieces are contained in buffers in the first transfer unit. As a result, a delay until the output of a retransmission data piece can be reduced.

The transmission device of the present example embodiment provides each output data piece with a number in accordance with a predetermined rule in the input/output processing unit. This configuration enables a data piece provided with a number in accordance with a predetermined rule to be output.

### [Hardware Configuration Example]

A configuration example of hardware resources for achieving each of the above-described transmission devices (10, 20, 30, 40, 50, and 60) in the respective example embodiments of the present invention by use of an information processing device (computer) will be described. Note that each transmission device may be achieved physically or functionally by use of at least two information processing devices. Each transmission device may also be achieved as a dedicated device. Only some functions of each transmission device may be achieved by use of an information processing device.

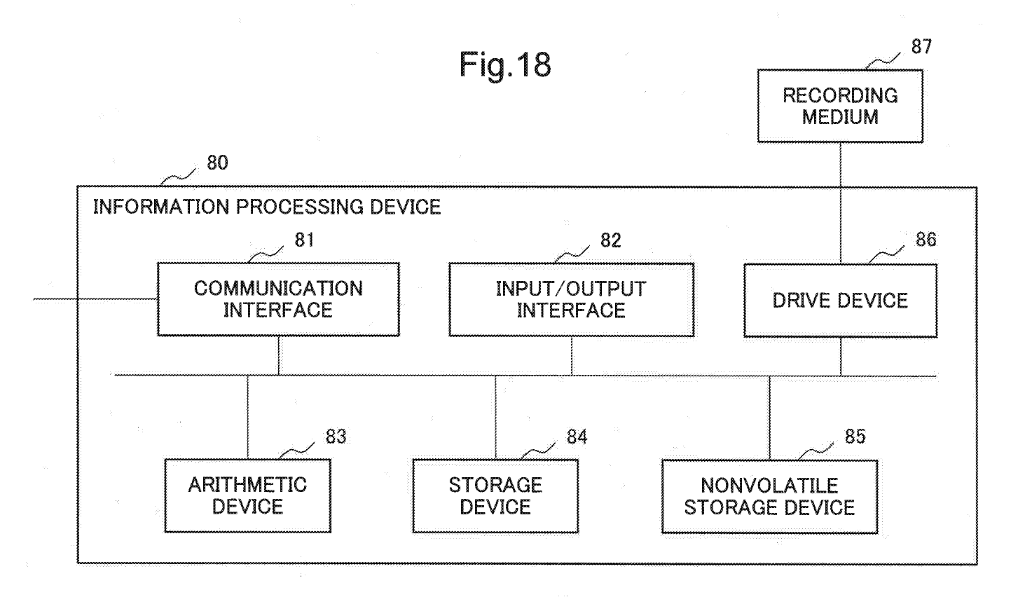

FIG. 18 is a diagram schematically illustrating a hardware configuration example of an information processing device that is capable of achieving transmission devices of the respective example embodiments of the present invention. An information processing device 80 includes a communication interface 81, an input/output interface 82, an arithmetic device 83, a storage device 84, a nonvolatile storage device 85, and a drive device 86.

The communication interface 81 is a communication means by which each of the transmission devices of the respective example embodiments communicates with an external device in a wired and/or wireless manner. Note that, when a transmission device is achieved using at least two information processing devices, the information processing devices may be interconnected in a communicable manner via the communication interfaces 81.

The input/output interface 82 is a man-machine interface, such as a keyboard, which is an example of an input device, and a display, which serves as an output device.

The arithmetic device 83 is an arithmetic processing device, such as a general-purpose central processing unit (CPU) and a microprocessor. The arithmetic device 83 is, for example, capable of reading various types of programs stored in the nonvolatile storage device 85 into the storage device 84 and performing processing in accordance with the read programs.

The storage device 84 is a memory device, such as a random access memory (RAM), that is accessible from the arithmetic device 83 and stores programs, various types of data, and the like. The storage device 84 may be a volatile memory device or a nonvolatile memory device.

The nonvolatile storage device 85 is, for example, a nonvolatile storage device, such as a read only memory (ROM) and a flash memory, and is capable of storing various types of programs and data and the like.

The drive device 86 is, for example, a device that processes reading and writing of data from and to a recording medium 87, which will be described below.

The recording medium 87 is an arbitrary recording medium, such as an optical disk, a magneto optical disk, and a semiconductor flash memory, that is capable of recording data.

Each of the respective example embodiments of the present invention may, for example, be achieved by configuring a transmission device by use of the information processing device 80 exemplified in FIG. 18 and providing the transmission device with a program that is capable of achieving functions described in the respective example embodiment described above.

In this case, the arithmetic device 83 executing a program provided to the transmission device enables each example embodiment to be achieved. Instead of all functions, some functions of a transmission device may be configured with the information processing device 80.

Further, the above-described program may be configured to be recorded in the recording medium 87 and appropriately stored in the nonvolatile storage device 85 at a shipping stage or an operation stage of a transmission device. Note that, in this case, as a provision method of the program, a method of installing the program in the transmission device by use of an appropriate jig at a production stage before shipping, an operation stage, or the like may be employed. As the provision method of the program, a general procedure, such as a method of downloading the program from the outside via a communication line like the Internet may also be employed.

The whole or part of the example embodiments disclosed above can be described as, but not limited to, the following supplementary notes.

(Supplementary Note 1)

A transmission device comprising:

a data input means for inputting a data piece;

a first transfer means;

a second transfer means;

a data transmission means for performing transfer of the data piece to the first transfer means;

a retransmission control means for performing determination of necessity of retransmission of the data piece;

a retransmission data transmission means for, when the retransmission is determined to be necessary, performing transfer of a retransmission data piece that is necessary to be retransmitted to the second transfer means; and

an input/output processing means for, in advance of at least any of the data piece remaining in the first transfer means at a point of time of the transfer of the retransmission data piece to the second transfer means, performing output of the retransmission data piece in the second transfer means to a same destination as that of the data piece in the first transfer means.

(Supplementary Note 2)

The transmission device according to supplementary note 1 further comprising:

a first data link processing means for transferring the data piece in a first data link buffer in a data link layer in the first transfer means to the input/output processing means; and

a second data link processing means for transferring the retransmission data piece in a second data link buffer in the data link layer in the second transfer means to the input/output processing means.

(Supplementary Note 3)

The transmission device according to supplementary note 2, wherein

the retransmission data transmission means provides the retransmission data piece with a flag indicating being the retransmission data piece and performs the transfer of the retransmission data piece to the second transfer means,

the transmission device further comprises a network processing means for, in accordance with the flag, transferring the data piece to the first data link buffer and the retransmission data piece to the second data link buffer.

(Supplementary Note 4)

The transmission device according to supplementary note 3, wherein

the first data link processing means stores a third data number of the data piece to be transferred to the input/output processing means in a state storage unit,

the network processing means stores a first data number of the data piece to be transferred to the first data link buffer in the state storage unit, and

the second data link processing means calculates the number of data pieces that the retransmission data piece has overtaken, based on the third data number and the first data number stored in the state storage unit.

(Supplementary Note 5)

The transmission device according to supplementary note 2 further comprising:

a first network processing means for transferring the data piece in a first network buffer in a network layer in the first transfer means to the first data link buffer; and

a second network processing means for transferring the retransmission data piece in a second network buffer in the network layer in the second transfer means to the second data link buffer,

wherein

the data transmission means performs the transfer of the data piece to the first transfer means by transferring the data piece to the first network buffer, and

the retransmission data transmission means performs the transfer of the retransmission data piece to the second transfer means by transferring the retransmission data piece to the second network buffer.

(Supplementary Note 6)

The transmission device according to supplementary note 5, wherein

the first data link processing means stores a third data number of the data piece to be transferred to the input/output processing means in a state storage unit,

the first network processing means stores a first data number of the data piece to be transferred to the first data link buffer in the state storage unit, and

the second data link processing means calculates the number of data pieces that the retransmission data piece has overtaken, based on the third data number and the first data number stored in the state storage unit.

(Supplementary Note 7)

The transmission device according to supplementary note 5 or 6, wherein

the first data link processing means stores a third data number of the data piece to be transferred to the input/output processing means in a state storage unit,

the data transmission means stores a second data number of the data piece to be transferred to the first network buffer in the state storage unit, and

the second data link processing means calculates the number of data pieces that the retransmission data piece has overtaken, based on the third data number and the second data number stored in the state storage unit.

(Supplementary Note 8)

The transmission device according to supplementary note 1 further comprising:

a first network processing means for transferring the data piece in a first network buffer in a network layer in the first transfer means to a data link buffer in a data link layer;

a second network processing means for transferring the retransmission data piece in a second network buffer in the network layer in the second transfer means to the data link buffer that the first transfer means and the second transfer means share; and

a data link processing means for transferring the data piece and the retransmission data piece in the data link buffer to the input/output processing means,

wherein

the data transmission means performs the transfer of the data piece to the first transfer means by transferring the data piece to the first network buffer, and

the retransmission data transmission means performs the transfer of the retransmission data piece to the second transfer means by transferring the retransmission data piece to the second network buffer.

(Supplementary Note 9)

The transmission device according to any one of supplementary notes 5 to 8, wherein

the first network processing means stores a first data number of the data piece to be transferred to the data link layer in a state storage unit,

the data transmission means stores a second data number of the data piece to be transferred to the first network buffer in the state storage unit, and

the second network processing means calculates the number of data pieces that the retransmission data piece has overtaken, based on the first data number and the second data number stored in the state storage unit.

(Supplementary Note 10)

The transmission device according to any one of supplementary notes 5 to 9, wherein

each of the first network processing means and the second network processing means stores a transfer condition for a communication flow in a state storage unit and, in accordance with the transfer condition in the state storage unit, performs the transfer of the data piece and the transfer of the retransmission data piece.

(Supplementary Note 11)

The transmission device according to supplementary note 10, wherein

the transfer condition includes a processing state of a packet filter.

(Supplementary Note 12)

The transmission device according to any one of supplementary notes 1 to 11, wherein

the retransmission control means performs the determination of the necessity of the retransmission, based on a received acknowledgement (ACK).

(Supplementary Note 13)

The transmission device according to any one of supplementary notes 1 to 12, wherein

the input/output processing means performs the output of the data piece and the retransmission data piece from one output interface.

(Supplementary Note 14)

The transmission device according to any one of supplementary notes 1 to 13, wherein

the input/output processing means rewrites data output numbers of the data piece and the retransmission data piece in accordance with a predetermined rule.

(Supplementary Note 15)

The transmission device according to supplementary note 14, wherein

the data output number is an IP identification (IPID) in an internet protocol (IP) header.

(Supplementary Note 16)

A transmission method comprising:

performing transfer of a data piece that is input from a data input unit to a first transfer unit;

performing determination of necessity of retransmission of the data piece;

when the retransmission is determined to be necessary, performing transfer of a retransmission data piece that is necessary to be retransmitted to a second transfer unit; and

in advance of at least any of the data piece remaining in the first transfer unit at a point of time of the transfer of the retransmission data piece to the second transfer unit, performing output of the retransmission data piece in the second transfer unit to a same destination as that of the data piece in the first transfer unit.

(Supplementary Note 17)

The transmission method according to supplementary note 16, wherein

the data piece in the first transfer unit is the data piece in a first data link buffer in a data link layer in the first transfer unit, and

the retransmission data piece in the second transfer unit is the retransmission data piece in a second data link buffer in the data link layer in the second transfer unit.

(Supplementary Note 18)

The transmission method according to supplementary note 17 comprising:

providing the retransmission data piece with a flag indicating being the retransmission data piece and performing the transfer of the retransmission data piece to the second transfer unit; and

in accordance with the flag, transferring the data piece to the first data link buffer and the retransmission data piece to the second data link buffer.

(Supplementary Note 19)

The transmission method according to supplementary note 18 comprising:

storing a third data number of the data piece the output of which is to be performed in a state storage unit;

storing a first data number of the data piece to be transferred to the first data link buffer in the state storage unit; and

calculating the number of data pieces that the retransmission data piece has overtaken, based on the third data number and the first data number stored in the state storage unit.

(Supplementary Note 20)

The transmission method according to supplementary note 17 comprising:

transferring the data piece in a first network buffer in a network layer in the first transfer unit to the first data link buffer; and

transferring the retransmission data piece in a second network buffer in the network layer in the second transfer unit to the second data link buffer; wherein

the transfer of the data piece to the first transfer unit is performed by transferring the data piece to the first network buffer, and

the transfer of the retransmission data piece to the second transfer unit is performed by transferring the retransmission data piece to the second network buffer.

(Supplementary Note 21)

The transmission method according to supplementary note 20 comprising:

storing a third data number of the data piece the output of which is to be performed in a state storage unit;

storing a first data number of the data piece to be transferred to the first data link buffer in the state storage unit; and

calculating the number of data pieces that the retransmission data piece has overtaken, based on the third data number and the first data number stored in the state storage unit.

(Supplementary Note 22)

The transmission method according to supplementary note 20 or 21 comprising:

storing a third data number of the data piece the output of which is to be performed in a state storage unit;

storing a second data number of the data piece to be transferred to the first network buffer in the state storage unit; and

calculating the number of data pieces that the retransmission data piece has overtaken, based on the third data number and the second data number stored in the state storage unit.

(Supplementary Note 23)

The transmission method according to supplementary note 16 comprising:

transferring the data piece in a first network buffer in a network layer in the first transfer unit to a data link buffer in a data link layer;

transferring the retransmission data piece in a second network buffer in the network layer in the second transfer unit to the data link buffer that the first transfer unit and the second transfer unit share; and

performing the output of the data piece and the retransmission data piece in the data link buffer; wherein

the transfer of the data piece to the first transfer unit is performed by transferring the data piece to the first network buffer, and

the transfer of the retransmission data piece to the second transfer unit is performed by transferring the retransmission data piece to the second network buffer.

(Supplementary Note 24)

The transmission method according to any one of supplementary notes 20 to 23 comprising:

storing a first data number of the data piece to be transferred to the data link layer in a state storage unit;

storing a second data number of the data piece to be transferred to the first network buffer in the state storage unit; and

calculating the number of data pieces that the retransmission data piece has overtaken, based on the first data number and the second data number stored in the state storage unit.

(Supplementary Note 25)

The transmission method according to any one of supplementary notes 20 to 24 comprising:

storing a transfer condition for a communication flow in a state storage unit and, in accordance with the transfer condition in the state storage unit, performing the transfer of the data piece and the retransmission data piece.

(Supplementary Note 26)

The transmission method according to supplementary note 25, wherein

the transfer condition includes a processing state of a packet filter.

(Supplementary Note 27)

The transmission method according to any one of supplementary notes 16 to 26 comprising:

performing the determination of the necessity of the retransmission, based on a received acknowledgement (ACK).

(Supplementary Note 28)

The transmission method according to any one of supplementary notes 16 to 27 wherein

the output of the data piece and the retransmission data piece is performed from one output interface.

(Supplementary Note 29)

The transmission method according to any one of supplementary notes 16 to 28 comprising:

rewriting data output numbers of the data piece and the retransmission data piece in accordance with a predetermined rule.

(Supplementary Note 30)

The transmission method according to supplementary note 29, wherein

the data output number is an IP identification (IPID) in an internet protocol (IP) header.

(Supplementary Note 31)

A transmission program causing a computer to execute:

a data transmission function of performing transfer of a data piece that is input from a data input unit to a first transfer unit;

a retransmission control function of performing determination of necessity of retransmission of the data piece;

a retransmission data transmission function of, when the retransmission is determined to be necessary, performing transfer of a retransmission data piece that is necessary to be retransmitted to a second transfer unit; and

an input/output processing function of, in advance of at least any of the data piece remaining in the first transfer unit at a point of time of the transfer of the retransmission data piece to the second transfer unit, performing output of the retransmission data piece in the second transfer unit to a same destination as that of the data piece in the first transfer unit.

(Supplementary Note 32)

The transmission program according to supplementary note 31 further causing the computer to execute:

a first data link processing function of transferring the data piece in a first data link buffer in a data link layer in the first transfer unit to the input/output processing function; and

a second data link processing function of transferring the retransmission data piece in a second data link buffer in the data link layer in the second transfer unit to the input/output processing function.

(Supplementary Note 33)

The transmission program according to supplementary note 32, wherein

the retransmission data transmission function provides the retransmission data piece with a flag indicating being the retransmission data piece and performs the transfer of the retransmission data piece to the second transfer unit, and

the transmission program further causes the computer to execute a network processing function of, in accordance with the flag, transferring the data piece to the first data link buffer and the retransmission data piece to the second data link buffer.

(Supplementary Note 34)

The transmission program according to supplementary note 33, wherein

the first data link processing function stores a third data number of the data piece to be transferred to the input/output processing function in a state storage unit,

the network processing function stores a first data number of the data piece to be transferred to the first data link buffer in the state storage unit, and

the second data link processing function calculates the number of data pieces that the retransmission data piece has overtaken, based on the third data number and the first data number stored in the state storage unit.

(Supplementary Note 35)

The transmission program according to supplementary note 32 further causing the computer to execute:

a first network processing function of transferring the data piece in a first network buffer in a network layer in the first transfer unit to the first data link buffer; and

a second network processing function of transferring the retransmission data piece in a second network buffer in the network layer in the second transfer unit to the second data link buffer,

wherein

the data transmission function performs the transfer of the data piece to the first transfer unit by transferring the data piece to the first network buffer, and

the retransmission data transmission function performs the transfer of the retransmission data piece to the second transfer unit by transferring the retransmission data piece to the second network buffer.

(Supplementary Note 36)

The transmission program according to supplementary note 35, wherein

the first data link processing function stores a third data number of the data piece to be transferred to the input/output processing function in a state storage unit,

the first network processing function stores a first data number of the data piece to be transferred to the first data link buffer in the state storage unit, and

the second data link processing function calculates the number of data pieces that the retransmission data piece has overtaken, based on the third data number and the first data number stored in the state storage unit.

(Supplementary Note 37)

The transmission program according to supplementary note 35 or 36, wherein

the first data link processing function stores a third data number of the data piece to be transferred to the input/output processing function in a state storage unit,

the data transmission function stores a second data number of the data piece to be transferred to the first network buffer in the state storage unit, and

the second data link processing function calculates the number of data pieces that the retransmission data piece has overtaken, based on the third data number and the second data number stored in the state storage unit.

(Supplementary Note 38)

The transmission program according to supplementary note 31 further causing the computer to execute:

a first network processing function of transferring the data piece in a first network buffer in a network layer in the first transfer unit to a data link buffer in a data link layer;

a second network processing function of transferring the retransmission data piece in a second network buffer in the network layer in the second transfer unit to the data link buffer that the first transfer unit and the second transfer unit share; and

a data link processing function of transferring the data piece and the retransmission data piece in the data link buffer to the input/output processing function,

wherein

the data transmission function performs the transfer of the data piece to the first transfer unit by transferring the data piece to the first network buffer, and

the retransmission data transmission function performs the transfer of the retransmission data piece to the second transfer unit by transferring the retransmission data piece to the second network buffer.

(Supplementary Note 39)

The transmission program according to any one of supplementary notes 35 to 38, wherein

the first network processing function stores a first data number of the data piece to be transferred to the data link layer in a state storage unit,

the data transmission function stores a second data number of the data piece to be transferred to the first network buffer in the state storage unit, and

the second network processing function calculates the number of data pieces that the retransmission data piece has overtaken, based on the first data number and the second data number stored in the state storage unit.

(Supplementary Note 40)

The transmission program according to any one of supplementary notes 35 to 39, wherein

each of the first network processing function and the second network processing function stores a transfer condition for a communication flow in a state storage unit and, in accordance with the transfer condition in the state storage unit, performs the transfer of the data piece and the transfer of the retransmission data piece.

(Supplementary Note 41)

The transmission program according to supplementary note 40, wherein

the transfer condition includes a processing state of a packet filter.

(Supplementary Note 42)

The transmission program according to any one of supplementary notes 31 to 41, wherein

the retransmission control function performs the determination of the necessity of the retransmission, based on a received acknowledgement (ACK).

(Supplementary Note 43)

The transmission program according to any one of supplementary notes 31 to 42, wherein

the input/output processing function performs the output of the data piece and the retransmission data piece from one output interface.

(Supplementary Note 44)

The transmission program according to any one of supplementary notes 31 to 43, wherein

the input/output processing function rewrites data output numbers of the data piece and the retransmission data piece in accordance with a predetermined rule.

(Supplementary Note 45)

The transmission program according to supplementary note 44, wherein

the data output number is an IP identification (IPID) in an internet protocol (IP) header.

(Supplementary Note 46)

A computer readable recording medium recorded with the transmission program according to any one of supplementary notes 31 to 45.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2016-099698, filed on May 18, 2016, the disclosure of which is incorporated herein in its entirety by reference.

### REFERENCE SIGNS LIST

10, 20, 30, 40, 50, 60 Transmission device
11 Data input unit
12 First transfer unit
13 Second transfer unit
14 Data transmission unit
15 Retransmission control unit
16 Retransmission data transmission unit
17 Input/output processing unit
21 First network processing unit
22 First data link processing unit
23 Second network processing unit
24 Second data link processing unit
25 Transport processing unit
31 Network processing unit
36 Retransmission data transmission unit
41 Data link processing unit
58 State storage unit
70 Reception device
71 Application
72 Transport reception unit
73 Data reception unit
74 ACK transmission unit
75 Network processing unit
76 Data link processing unit
77 Input/output processing unit
90 Network
91 TCP connection
80 Information processing device
81 Communication interface
81 Input/output interface
82 Arithmetic device
83 Storage device
84 Nonvolatile storage device
86 Drive device
87 Recording medium

1. A transmission device comprising:
a data inputter configured to input a data piece;
a first transmitter;
a second transmitter;
a data transmitter configured to perform transfer of the data piece to the first transmitter;
a retransmission controller configured to perform determination of necessity of retransmission of the data piece;
a retransmission data transmitter configured to, when the retransmission is determined to be necessary, perform transfer of a retransmission data piece that is necessary to be retransmitted to the second transmitter; and
an input/output processor configured to, in advance of at least any of the data piece remaining in the first transmitter at a point of time of the transfer of the retransmission data piece to the second transmitter, perform output of the retransmission data piece in the second transmitter to a same destination as that of the data piece in the first transmitter.

2. The transmission device according to claim 1 further comprising:
a first data link processor configured to transfer the data piece in a first data link buffer in a data link layer in the first transmitter to the input/output processor; and
a second data link processor configured to transfer the retransmission data piece in a second data link buffer in the data link layer in the second transmitter to the input/output processor.

3. The transmission device according to claim 2, wherein
the retransmission data transmitter provides the retransmission data piece with a flag indicating being the retransmission data piece and performs the transfer of the retransmission data piece to the second transmitter,
the transmission device further comprises a network processor configured to, in accordance with the flag, transfer the data piece to the first data link buffer and the retransmission data piece to the second data link buffer.

4. The transmission device according to claim 3, wherein
the first data link processor stores a third data number of the data piece to be transferred to the input/output processor in a state storage,
the network processor stores a first data number of the data piece to be transferred to the first data link buffer in the state storage, and
the second data link processor calculates the number of data pieces that the retransmission data piece has overtaken, based on the third data number and the first data number stored in the state storage.

5. The transmission device according to claim 2 further comprising:
a first network processor configured to transfer the data piece in a first network buffer in a network layer in the first transmitter to the first data link buffer; and
a second network processor configured to transfer the retransmission data piece in a second network buffer in the network layer in the second transmitter to the second data link buffer,
wherein
the data transmitter performs the transfer of the data piece to the first transmitter by transferring the data piece to the first network buffer, and
the retransmission data transmitter performs the transfer of the retransmission data piece to the second transmitter by transferring the retransmission data piece to the second network buffer.

6. The transmission device according to claim 5, wherein
the first data link processor stores a third data number of the data piece to be transferred to the input/output processor in a state storage,
the first network processor stores a first data number of the data piece to be transferred to the first data link buffer in the state storage, and
the second data link processor calculates the number of data pieces that the retransmission data piece has overtaken, based on the third data number and the first data number stored in the state storage.

7. The transmission device according to claim 5, wherein
the first data link processor stores a third data number of the data piece to be transferred to the input/output processor in a state storage,
the data transmitter stores a second data number of the data piece to be transferred to the first network buffer in the state storage, and
the second data link processor calculates the number of data pieces that the retransmission data piece has overtaken, based on the third data number and the second data number stored in the state storage unit.

8. The transmission device according to claim 1 further comprising:
a first network processor configured to transfer the data piece in a first network buffer in a network layer in the first transmitter to a data link buffer in a data link layer;
a second network processor configured to transfer the retransmission data piece in a second network buffer in the network layer in the second transmitter to the data link buffer that the first transmitter and the second transmitter share; and
a data link processor configured to transfer the data piece and the retransmission data piece in the data link buffer to the input/output processor,
wherein
the data transmitter performs the transfer of the data piece to the first transmitter by transferring the data piece to the first network buffer, and
the retransmission data transmitter performs the transfer of the retransmission data piece to the second transmitter by transferring the retransmission data piece to the second network buffer.

9. The transmission device according to claim 5, wherein
the first network processor stores a first data number of the data piece to be transferred to the data link layer in a state storage,
the data transmitter stores a second data number of the data piece to be transferred to the first network buffer in the state storage, and
the second network processor calculates the number of data pieces that the retransmission data piece has overtaken, based on the first data number and the second data number stored in the state storage.

10. The transmission device according to claim 5, wherein
each of the first network processor and the second network processor stores a transfer condition for a communication flow in a state storage and, in accordance with the transfer condition in the state storage, performs the transfer of the data piece and the transfer of the retransmission data piece.

11. The transmission device according to claim 10, wherein
the transfer condition includes a processing state of a packet filter.

12. The transmission device according to claim 1, wherein
the retransmission controller performs the determination of the necessity of the retransmission, based on a received acknowledgement (ACK).

13. The transmission device according to claim 1, wherein
the input/output processor performs the output of the data piece and the retransmission data piece from one output interface.

14. The transmission device according to claim 1, wherein
the input/output processor rewrites data output numbers of the data piece and the retransmission data piece in accordance with a predetermined rule.

15. The transmission device according to claim 14, wherein
the data output number is an IP identification (IPID) in an internet protocol (IP) header.

16. A transmission method comprising:
performing transfer of a data piece that is input from a data inputter to a first transmitter;
performing determination of necessity of retransmission of the data piece;
when the retransmission is determined to be necessary, performing transfer of a retransmission data piece that is necessary to be retransmitted to a second transmitter; and
in advance of at least any of the data piece remaining in the first transmitter at a point of time of the transfer of the retransmission data piece to the second transmitter, performing output of the retransmission data piece in the second transmitter to a same destination as that of the data piece in the first transmitter.

17-30. (canceled)

31. A computer readable recording medium recorded with a transmission program causing a computer to execute:
a data transmission function of performing transfer of a data piece that is input from a data inputter to a first transmitter;
a retransmission control function of performing determination of necessity of retransmission of the data piece;
a retransmission data transmission function of, when the retransmission is determined to be necessary, performing transfer of a retransmission data piece that is necessary to be retransmitted to a second transmitter; and
an input/output processing function of, in advance of at least any of the data piece remaining in the first transmitter at a point of time of the transfer of the retransmission data piece to the second transmitter, performing output of the retransmission data piece in the second transmitter to a same destination as that of the data piece in the first transmitter.

32-46. (canceled)
